(19) United States
(12) Patent Application Publication
(10) Pub. No.: US 2005/0228747 A1
(43) Pub. Date: Oct. 13, 2005

(54) Cash exercise performance target securities (Cash xPRTs)

(76) Inventor: Michael A. Gumport, Summit, NJ (US)

Correspondence Address: Ward & Olivo, Suite 400, 382 Springfield Avenue, Summit, NJ, 07901, US

(21) Appl. No.: 11/104,087

(22) Filed: Apr. 12, 2005

Related U.S. Application Data
(60) Provisional application No. 60/562,046, filed on Apr. 13, 2004.

(51) Int. Cl. G06F 17/60

(52) U.S. Cl. 705/37; 705/35

(57) ABSTRACT

Disclosed is a method of issuing a novel security in order to: 1) Raise capital, 2) Perform cashless buybacks of securities, and 3) Provide trading vehicles with unique risk/reward characteristics. The security may be structured to sell at a price above the underlying security's current market price and, potentially, above the underlying security's future market price while providing either a positive or acceptable risk/return to all parties involved. In addition, the invention provides a method to deal with certain risks inherent in the structure of Cash xPRTs and a method and means to price those risks and to solicit underwriters to assume those risks. Also, a method and means to solicit exchanges and regulatory authorities to enhance the robustness of capital markets through volume trading of Cash xPRTs with standardized features is disclosed.

### CROSS REFERENCE TO RELATED APPLICATIONS

This application claims the benefit of U.S. Provisional Application No. 60/562,046, filed on Apr. 13, 2004.

### FIELD OF THE INVENTION

This invention relates to the field of finance and financial securities. More specifically, the invention relates to an adjustable return, exotic security, a method of offering the same for sale, and a method for valuing the novel security.

### BACKGROUND OF THE INVENTION

Corporations raise capital through the issuance of financial securities. The two fundamental types of securities are equity and debt. In their purest forms, equity securities never require a mandatory outlay of cash by the issuer (except upon liquidation, assuming residual value), and debt securities always require return of principal plus interest. Investment banks have created numerous types of securities that are intermediate or hybrid forms of equity and debt including, for instance, preferred shares, convertible securities, zero coupon debt, pay in kind securities, and attached or detachable warrants. In addition, these financial instruments may include various “put” and/or “call” features, levels of seniority, and other rights (including various voting, registration, and liquidation rights).

The proliferation of hybrid security types serves the purpose of better matching the various risk/reward appetites of investors with the cash flow capacities of issuers. By better matching demand (investor risk/reward preferences) with supply (cash flow of security issuers), the depth, breadth, and liquidity (i.e. “robustness”) of capital markets is improved. A robust capital market enhances the efficiency of capital allocation. As a result of the efficiency of capital markets, it is often possible for investors to enhance returns in relatively secure investments, for instance, through a covered call strategy, and for issuers to fund even their riskiest capital projects, for instance, by selling tranches of reduced risk securities. Because of robust financial markets, even companies in bankruptcy often may obtain “debtor in possession” financing with the benefit that commerce may continue while issues of ownership are decided in an orderly manner.

Companies frequently are in need of financing at fundamentally inopportune times. For example, particularly within industries with high, cyclical growth (such as some segments of the technology market), a company's growth rate and/or cash requirements may at times exceed its return on equity. During the period when growth prospects exceed equity returns, if capacity expansion, new product development, and/or other programs in support of future growth are to continue uninterrupted, then a company must either have set aside sufficient cash in earlier periods or must seek outside funding adequate to bridge the gap between current returns and growth capital requirements.

If a company needs to finance at an inopportune time, it may find that it can issue new securities, particularly equity securities, only on unattractive terms, if at all. For instance, if a need for financing is precipitated by a fundamental shortfall (i.e. a temporary shortfall in orders, sales or profits during a time when new investments are required to fund future growth), that fundamental shortfall may also seriously depress a company's stock price. As a result, unless the company is willing to countenance substantial dilution, the issuance of equity securities at a reasonable price may be effectively “closed” just when new equity capital is most needed.

The financial difficulties posed by a fundamental shortfall and the consequent shutdown of access to equity capital may be compounded by the creation of structural imbalances if alternative capital sources are tapped. For example, if the equity market is closed, a company might finance through debt (or hybrids with debt features, such as convertibles). However, in the same way that certain investments are inappropriate for certain investors, certain classes of security are inappropriate for certain issuers. In the case of a cyclical growth company that has suffered a shortfall in fundamentals, the use of debt, particularly if terms are relatively expensive (as may be the case during a period of shortfall), may itself precipitate additional stock price pressure due to the perception of increased financial risk (“structural” risk) posed by the new cash obligations. So, while debt may solve short term cash needs, it may exacerbate long term problems by further increasing a company's cost of capital. Over time, a higher cost of capital may drain the company's resources and/or preclude it from seeking additional necessary funding from the capital markets at a reasonable price.

Security analysts typically define a company's “enterprise value” as the market value of its equity securities plus the market value of its debt securities minus any excess cash on hand. Theories to the contrary notwithstanding (which may be based on certain tax advantages of debt), it has been empirically observed that, if two growth companies are identical in all respects, but one growth company is funded solely with debt (“levered”) and the other solely with equity (“unlevered”), then the enterprise value of the growth company funded with debt will become increasingly less than the enterprise value of the company funded solely by equity. The difference in enterprise value becomes most pronounced as the levered company's debt levels rise above a range viewed as normal for the industry.

The difference in enterprise value of levered growth companies versus unlevered growth companies may be explained by the increased financial risk caused by debt. The higher level of fixed expenses created by debt combined with the underlying variability of operating earnings increases the risk of default for levered companies. Consequences of default may include an adverse impact on business (customers may flee a defaulting company), a significant degradation in future prospects due to structural limitations (debt covenants and/or associated risks may impose barriers to the receipt of new capital or even result in the outflow of capital), or even a massive change in ownership (reorganization). So, although limited leverage may generate tax advantages particularly for companies with stable cash flow and so increase enterprise value, excess leverage depresses enterprise value due to the increased risk assumed concomitant with increased debt, and the reduction in enterprise value to debt leverage can be particularly marked for cyclical growth companies with less predictable cash requirements.

In some highly cyclical industries, any debt may be excessive. It is has been empirically observed that in some cyclical growth industries, cash-rich companies appear to trade at substantial premiums to their levered comparables. The valuation premium accorded unlevered companies may be attributed in part to the “quality” of the cash rich companies but also in part appears due to the financial security provided by the cash cushion itself.

As a result of the perceived negative impact of debt on enterprise value, particularly in cyclical growth industries, companies in these industries often resort to the sale of various hybrids (such as convertibles) or, in more difficult equity markets, may offer warrants. Hybrids, however, can be an imperfect solution. Convertibles, for instance, are still a form of debt. While the cost of capital from the issuance of convertibles (as measured by the interest rate and conversion premium) may seem superficially low, the actual cost is often extremely high when the cost of the impact on outstanding securities is included (issuance of convertibles is often accompanied by pressure on a company's equity securities). Similarly, the issuance of warrants may result in substantial dilution of reported earnings and/or a substantial overhang of securities for which no cash has been received. While enterprise value may be unaffected by the warrants, there is a transfer of wealth from existing equity holders to new investors which may be extremely costly. In brief, the issuance of hybrid securities and/or warrants in order to fund growth during a period of fundamental shortfall may, like the issuance of debt, inappropriately result in additional pressure on a company's enterprise value and/or costly dilution.

While a company's enterprise value may be forced lower due to a combination of fundamental and financial issues, the decline by definition will be short term if the company is truly undervalued. If so, management should far prefer to repurchase its outstanding securities (which are underpriced) rather than issue new securities which may cause additional structural pressure (if debt is issued) or result in costly dilution (if equity is issued).

Valuation (underpriced securities) is the most reasonable basis for a management buyback of securities: the company can repurchase its shares at a low price today and resell them in the future at a higher price. Typically, however, the most appropriate time for a buyback may also be the same time a company is least able to execute one. When a company's stock is most depressed (most ripe for a buyback), the wherewithal to execute a substantial stock buyback is often at its nadir. Consequently, unless a company has adequate excess cash on hand, the repurchase of its securities in substantial volume will require additional financing. Historically, the principal means of financing buybacks has been with debt securities (issuing stock for the repurchase of stock would accomplish nothing). But to fund the outlay of additional cash for a buyback through assumption of debt may be counterproductive: Even if the stock initially was undervalued, the debt leverage may cause the stock to fall further. Often the risks inherent with the assumption of debt provide a strong disincentive to prosecuting a buyback even if a company's equity value appears substantially underpriced.

A transaction that is currently available avoids in part the drawbacks of other existing debt or equity issuances as a means of financing undervalued situations. In the case of Ramtron's Jan. 12, 1994 issuance of 3.334 million shares of Series B Convertible Preferred Stock (convertible into Common Stock and Series C Convertible Performance Right Preferred Stock), for example, the return to the investor is a function of the future price of the underlying security, and the company's cost of equity capital is inversely related to the future price of the stock. Each Ramtron type Performance Right would convert into a certain number of shares at the expiration of a timeframe. The number of shares into which a Right was convertible would decline as the price of the stock rose (an investor pays a fixed price and subsequently receives a number of shares that will vary as an inverse function of the performance of the stock). Consequently, for a company that issues Ramtron type Performance Rights, as the issuer's future stock price increases, the cost of its equity capital secured through past issuance of Performance Rights falls.

The Ramtron Performance Right is an equity security with a variable Conversion Ratio by means of which it provides:
1) Leveraged exposure (Lv1a) to an underlying Security up to a chosen Cutback Target price (CBt).
2) A Conversion Ratio Formula to provide a varying Conversion Ratio between the Cutback Target CBt and the Performance Target (“Pt”) and structured to generate a desired target intrinsic value (“Keep 1” or K1) at the Performance Target.
3) Ongoing final leveraged exposure (Lv1b) at price points above the Performance Target.

The present invention, a Cash eXercise Performance Right Security (“Cash xPRT”), provides an instrument and described use to capitalize on underpriced securities including specifically underpriced equity securities. The Cash xPRT includes features that distinguish it from existing securities including the Ramtron Performance Right.

The Ramtron Performance Right lacks certain features of the present invention. In particular, the Ramtron Performance Right converts directly into stock upon reaching a Target, whereas a Cash xPRT at Target undergoes an intermediate conversion (“Option Conversion” feature) into a short term “Conversion Option” (“Acceleration Option”, warrant, or other intermediate security) which may be exercisable for cash or other consideration and that may optionally include unique additional terms (including, among others, “Liquidation Value”, which may be cash or alternative conversion rights such as a “Binary Conversion Right”).

The additional standard features of Cash xPRTs (including the “Conversion Option” feature) and additional optional features of Cash xPRTs (including “Liquidation Value” applicable to the Conversion Option) provide various benefits relative to Performance Rights. Additional benefits include, among others, alternative outcomes for the Issuer (cash receipts) and facilitation of offerings on an underwritten basis. The manner in which a Cash xPRT is structured allows the additional features to be offered while maintaining or improving inducements for orderly trading. A Performance Right, unlike the present invention, secures no additional cash upon the attainment of a Performance Target, lacks features that are conducive to securing the services of an underwriter, and allows no provision for terms that, among other purposes, facilitate orderly trading.

The standard and optional features of a Cash xPRT that enable it to secure cash capital at a premium valuation (optionally through underwritten transactions and in a structure conducive to orderly trading) also fundamentally differ from the mechanism by which other existing hybrids (for instance, convertibles) operate. Convertible instruments (“Convertibles”), by definition, include conversion ratios and also routinely include acceleration features. However, the Cash xPRTs' standard feature of a Conversion Option and its manner of application of optional features (such as Acceleration and Liquidation Value) are distinctive. Also, Convertibles and related hybrid instruments are debt or special classes of equity and so include dividends (interest) and/or capital (principal) repayment terms as inducements to investors. Optionally, a Cash xPRT could include dividend (interest) or capital (principal) payments and enjoy status as preferred equity (or debt), but these additional, optional features are not among the claimed standard and optional features of Cash xPRTs. In particular, a Cash xPRT may be issued as equity pari passus with (or below) the lowest class of common and still have attributes attractive to Issuer, Investor, Trader, and, optionally, Underwriter. The claimed standard and optional features of Cash xPRTs permit them to operate in a manner that is distinct from available convertible preferred, convertible debt and other convertible hybrids, and the combination of features included in a Cash xPRT, even absent any preference, seniority, dividend, interest or other inducement, may be structured to provide an attractive instrument to both the Issuer and Investor particularly in situations where debt financing is unsuitable.

In theory, a Cash xPRT similar to the example case could be approximated by aggregating a bundle of issuer-backed (“primary”) securities. Such an “approximate” Cash xPRT could be made through the purchase and sale in public markets of a bundle of just three types of securities:
1) In general, a first, long position in 1.00 share of the underlying Security plus a fractional share (“Leverage Factor”) of the Security to produce Leverage 1a (“Lv1a”). For instance, in the example (with a chosen value of Lv1a=1.1600), the first component position is a long position of 1.1600 shares of the underlying Security.
2) In general, a second, short call position (the “Transition Target Options” or “Cutback Target Options”) with a strike price equal to a selected “Transition Target” or “Cutback Target” (“CBt”). The quantity of Cutback Target Options will equal Lv1a plus an incremental number of short call positions sufficient to create intrinsic value for the package of securities equal to a desired number, Keep1 (K1), at selected Performance Target Pt. In the example case (with chosen values of Lv1 a=1.1600, K1=$124.00, CBt=$137.75, Pt=$145.00), the desired results can be achieved through a second, 6.0966 share short position in 3-year $137.75—strike calls.
3) In general, a third, complementary, long position (the Target Options) with a strike price equal to a selected Performance Target (“Pt”) in a quantity sufficient so that
   i. The sum of Leverage 1a (Lv1a)
   ii. Minus the Cutback Target Options
   iii. Plus the Target Options
   iv. Combine to equal a desired Leverage 2 (Lv2).
For instance, in this example (with chosen value Lv2=1.2000), the solution is a third, Target Options ($145.00—strike) position in a quantity equal to 6.1366 (e.g., Lv1a of 1.1600 minus the 6.0966 Cutback Target Options plus the 6.1366 Target Options produces Lv2 equal to 1.2000).

Few primary issues (securities backed by the company the securities represent) of publicly (listed) or privately (unlisted) options are available from which the necessary bundles could be constructed. When, in rare instances, these primary securities exist, available strike prices and maturities are extremely limited, and features on these rare, available primary options (or warrants) typically are restricted to the most rudimentary and standard terms (a strike price and maturity). It would be impossible to find the necessary ratio of available options to create a Synthetic Cash xPRT based on trading available options or warrants from original issuers.

An alternative to replicating approximate Cash xPRTs with bundles of issuer backed securities gathered from public and private exchanges would be instead to supplement primary securities with bundles of “broker backed” options (which may be referred to as “secondary” or, by some, as “tertiary” derivative securities). A “Synthetic” Cash xPRT might be created from such a combination of primary and broker-backed securities. The vast majority of listed and unlisted options are “broker backed” (usually by way of the Options Clearing Corporation, “OCC”) rather than “issuer backed” (backed by the company that issues the underlying security), and numerous series of broker-backed options trade in volume on a regular basis with various series of strike prices and maturities. However, despite the large number of publicly listed maturities and strike prices for broker-backed options, the available maturities, strike prices, and ratio volumes of these securities would address only a small fraction of potentially desirable combinations. Notably, long term options (LEAPs) are listed for only a small percentage of companies, and the longest term LEAPs have maturities, at most, between 20 and 32 months, whereas the attributes of Cash xPRTs may be most attractive to issuers and investors when the instrument's term is on the order of 3 years. Consequently, in practice, the opportunity to assemble Synthetic Cash xPRTs from primary securities plus listed, broker-backed securities is, at best, severely limited. In any case, the described Synthetic Cash xPRT composed of bundles of primary securities plus listed standard option securities would still be just an “Approximate” Cash xPRT: A Synthetic Cash xPRT based in part on standard listed options would not include key features of Cash xPRTs, such as, for instance, Acceleration (and Acceleration related optional features such as Liquidation Value). In short, listed securities do not provide a viable pool for development of any significant activity in Synthetic Cash xPRTs, and no recognizable activity exists in listed markets for the aggregation, marketing, and trading of bundles of securities equivalent to Synthetic Cash xPRTs.

To create a better Synthetic Cash xPRT (one that more closely approximates the characteristics of a Cash xPRT than is possible either with primary securities alone and/or with listed options) from combinations of existing securities, the Synthetic Cash xPRT needs to be built with bundles of options that, at a minimum, include “contingent knock” features. “Contingent knock” features are unavailable on standard listed options. In special cases (large volume transactions), investment banks, brokers, hedge funds or other entities may enter into unlisted option type contracts on securities, and unlisted option contracts may contain various unusual features as a matter of negotiation. So, it would be theoretically possible to more closely approximate the features of a Cash xPRT by assembling components (or entering into integral contracts) in the unlisted options market.

In fact, if the Cash xPRT invention (including the security and its use) has value, then it would already have been invented in the unlisted securities market. In particular, the unlisted market is broad, competitive, robust and innovative. Because there are far more investors than companies, and because there are numerous sophisticated derivatives investors, it might be expected that an unlisted market for Synthetic Cash xPRTs (or an equivalent bundle of securities) would precede the development of a market for primary issuances. However, various impediments have prevented the development of an unlisted Synthetic Cash xPRTs market:
1) Fragmented market. The potential market for Synthetic Cash xPRTs is extraordinarily fragmented. Innumerable potential combinations of securities can be used to form exponentially more innumerable Synthetic Cash xPRTs. Absent standardized, high volume offerings, any individual effort is likely to be frustrated (an aggregated bundle of securities most likely will require disaggregating for resale to a third party).
2) Lack of competitive quotes. Competitive bid/ask quotes on the multiple component parts needed to assemble Synthetic Cash xPRTs are generally unavailable on a real time basis if at all; multiple spreads may be required if Cash xPRTs are assembled through several sources, and, in the aggregate, multiple spreads will tend to be an excessive cost.
3) Complex tax treatment. Complex tax laws regarding straddles (including rules on “qualified covered calls” and their interplay with “identified straddles”) apply to combinations of securities such as Synthetic Cash xPRTs if the combination is bought other than as an integral whole.
4) Counterparty risk. Counterparty integrity limits synthetic market participation either due to the investment mandates of investor pools (such as the investment charters of mutual funds), the relative sophistication required for participation in the synthetics market, and/or the real risks entailed by derivatives market transactions particularly in unlisted securities. Simply put, an investor in broker-backed synthetics faces the added risk of counterparty default.
5) Limited supply. Supply of the component parts necessary to assemble Synthetic Cash xPRTs is limited or nonexistent. Synthetic Cash xPRTs must be assembled by means of interbroker transactions executed through the members of the Options Clearing Corporation (“OCC”) or similar organization in the case of listed securities or through investment brokers in the case of unlisted securities. The issuers (first, the OCC and its affiliated brokers as a proxy for the investors they represent, and, second, private market bankers) may supply the component parts for Synthetic Cash xPRTs, but, in practice, they are rarely if ever issued because of the exotic nature of the components (“contingent knock” calls, “ratchets”, “liquidation rights”.), uncertain costs (multiple spreads on securities without competitively listed, real time bid/ask quotes), fragmented markets (lack of standardized product), and questions on counterparty integrity. Some features, particularly an Underwriter Guarantee, may be impossible to duplicate in the synthetics market.

Even if the factors that have forestalled development of Synthetic Cash xPRTs in the unlisted market did not exist, unlisted originations and trading would still be limited to “broker backed” Synthetic Cash xPRTs. Primary (issuer backed) Cash xPRTs can only be originated by the corporate issuer of the underlying Security, and the risk characteristics of primary originations is significantly different from the risk characteristics of broker-backed originations.

It is likely that the absence of listed or unlisted Synthetic Cash xPRT market activity has made it impractical for corporations to consider original issuances of Cash xPRTs for the purposes of securing capital or to execute Cashless Buybacks. In any case, for whatever reason, a primary market for originations of Cash xPRTs does not exist.

A principal impediment to the development of a Cash xPRTs market may be that the value advancement provided by the combination of the component parts that constitute a Cash xPRT is shared between investors, issuers, traders and underwriters. No single party sufficiently appreciates the total value advancement to take the initiative to manufacture, assemble and market the components as integral units in large volume with standard features. Again, in any case and for whatever reason, no recognizable activity currently exists in the equivalent of either broker-backed Synthetic Cash xPRTs or primary, issuer-backed approximate Cash xPRTs.

### SUMMARY OF THE INVENTION

The use of the term “stock” is not meant to limit the application of the invention to certain securities. A claimed business practice use for Cash xPRTs is to secure equity capital at a premium valuation either through sale of Cash xPRTs or through a Cashless Buyback exchange offer. In these claimed cases, the underlying security is equity (common shares). But any other mention of “stock” in conjunction with Cash xPRTs is for convenience and clarity and serves as a substitute for reference to “the prime underlying security.” The prime underlying security for Cash xPRTs will typically be referred to as common shares (i.e. “stock”) but could be any class of securities whether debt, equity, a derivative, a hybrid, or a “notional security” such as a benchmark or index. Similarly, the use of the term “company” is not meant to limit the use of the invention to one type of entity. An issuer may be any entity, and the security may be issued on a primary basis (where the security or package of securities is composed entirely of issues backed by an entity whose performance determines their value) or a broker-backed basis (where the security is a package composed in whole or in part of issues, for example, CBOE listed options, backed by a third party unrelated to the underlying entity whose performance determines value).

The invention advanced by the applicant creates a new class of securities through a distinctive implementation of a combination of features. The new class of securities is particularly suited for use by undervalued companies seeking additional funding or considering buybacks, particularly equity buybacks, and optionally advances a means for underwriters to facilitate the offering of this new class of securities including a means for underwriters to analyze assumed risk.

The benefits of Cash xPRTs (Cash eXercise Performance Target Securities) may extend to multiple parties. For company issuers, Cash xPRTs provide corporations with a new degree of freedom in their financial management. For investors, Cash xPRTs provide a unique risk/reward return profile that may better match an investor's risk tolerance. For financial intermediaries, Cash xPRTs provide opportunities to provide risk hedging services to both Cash xPRT issuers and investors, including services with very substantial utility (a true underwriting in which the financial intermediary shoulders substantial risks that neither the issuer nor the investor may be willing to bear absent disproportionate concessions). Moreover, insofar as Cash xPRTs provide a unique risk/reward profile within a security whose general terms are standardized and, optionally, may be publicly traded, Cash xPRTs may improve the overall efficiency of the capital markets.

The present invention provides for a method (solicitation, including costing of an intermediary's potential risk arbitrage services) and means (Cash xPRTs) to sell a security (typically, but not exclusively, convertible into common shares ultimately through a distinctive Option Conversion feature). Cash xPRTs may be structured to sell at a price above the underlying security's current market price and, potentially, above the security's future market price while providing either a positive or acceptable risk/return to all parties (the buyer, the seller, and the intermediary). A method of analysis for Cash xPRTs is provided that identifies, defines and prices a hedging service associated with Cash xPRTs appropriate for underwriters as well as individual hedge traders. The identified hedging service includes disclosure of a means to analyze, price and transfer (sell to an intermediary) risks unique to Cash xPRTs. For those Cash xPRTs which are publicly listed or otherwise tradeable, the optional hedging service described in the invention improves the trading characteristics of Cash xPRTs and enhances their suitability and attractiveness to large classes of issuers and investors, and it is anticipated the hedging analysis and pricing system will be of interest both to financial firms in the business of providing underwriting services and to traders of derivative securities.

In the preferred model of transactions, the component parts of Cash xPRTs would not be detachable but rather trade as an integral whole. Nonetheless, Cash xPRTs may be considered to consist of a distinctive combination of existing (though exotic) securities in an integral package. In theory, the component parts of the package include a prime underlying security (for instance, a common share, i.e. stock), options on that prime underlying security or its equivalent (a number of long or short calls, typically European style, at a first strike price and an approximately complementary number of short or long calls at a higher, second strike price) where the options include highly unusual terms (contingent “knock” features whereby, once a target price is met, the options become short term and may shift in style, for instance, from European to American). A feature of Cash xPRTs that in certain instances might have value (particularly after a robust Cash xPRT market is established) would be to make the component parts of Cash xPRTs detachable.

Standard features of a Cash xPRT include provisions for:
1) Leveraged exposure (“Leverage 1a” or “Lv1a”) to an underlying Security up to a chosen “Cutback Target” (“CBt”) by means of an “Initial Conversion Ratio” (“Initial Cr”),
2) A “Conversion Ratio Formula” that modifies the Conversion Ratio Cr between Cutback Target CBt and the “Performance Target” (“Pt”) with the result that Conversion Ratio Cr at Performance Target Pt equals a defined, selected value (“Leverage 1b” or “Lv1b”); Lv1b times Performance Target Pt equals the security's intrinsic value (“Keep 1” or “K1”) at Performance Target Pt. The Transition Range could be reduced to zero, so, the Conversion Ratio Formula may be viewed as optional. However, in practice, a zero transition range seems likely to be the exception rather than the rule, so we refer to this feature as a standard feature.
3) An Acceleration mechanism at Performance Target Pt that converts the instrument into a short term option (the “Conversion Option” or “Acceleration Option”). The Conversion Option's terms (strike price and quantity) provides both:
   i. Intrinsic value (“Keep 2” or “K2”, a value which may differ from K1) at Performance Target Pt
   ii. Ongoing leveraged exposure (“Leverage 2” or “Lv2”) at price points above the Conversion Option's strike price.

The combination of the component parts of a Cash xPRT package creates a valuable set of features and a diverse range of applications not currently well addressed by existing financial instruments. A Cash xPRTs offering includes a defined underlying reference security (“stock”), an “Initial Conversion Ratio” including a “Leverage Factor” (“Lv1a”) that defines the number of underlying securities into which Cash xPRTs are initially convertible within or at a certain timeframe (“Maturity”, “Term” or “Expiration”), a “Trigger Price” (or “Target Price”, “Pt”) with associated “Acceleration” terms, a “Conversion Option” feature with associated terms (“Strike Price”, “Liquidation Value” including “Binary Conversion Rights”, “Term”, “Style”, “Maturity”, “Underwritten Guarantee”, “Expiration”) that govern the conversion of Cash xPRTs after Target Price Pt has been reached. Optionally, Cash xPRTs may also include a “Transition Target” (or “Cutback Target”, “CBt”), a “Transition Conversion Ratio” governed by a “Transition Conversion Formula”, and additional Transition Conversion features such as, among others, a “Ratchet” and additional, alternative, transition “Acceleration” rights.

The combination of features embodied in the proposed Cash xPRT invention facilitates the potential issuance of stock at a premium price while providing positive or acceptable risk/return to all parties (to the issuer, to the buyer, and, if utilized, to the intermediary underwriter) in a manner distinctively different from existing vehicles such as Performance Rights, convertibles and/or other known equity, debt or hybrid vehicles, and this combination of features lends itself to a mode of deployment (Cashless Buyback exchange offers) in which it produces distinctively superior results to those achievable with existing vehicles.

The Cash xPRT invention is designed to be uniquely attractive as a financing instrument for undervalued companies, and it is an object of the present invention in particular (but not exclusively) to facilitate capital acquisition for companies as original issuers of Cash xPRTs. Cash xPRTs may be used as original issues: 1) To raise capital (an offering by a corporate issuer); 2) In an exchange offer (a “Cashless Buyback”); or 3) For other corporate purposes. Due to the distinctive characteristics of Cash xPRTs relative to existing debt, equity or hybrid securities, it is anticipated that financing through Cash xPRTs will be especially useful to companies that face a temporary shortfall in their stock price and for whom the assumption of debt is deemed unwise, or for the sale of temporarily underpriced or illiquid, large blocks of stock. Among other attractive features to issuers, Cash xPRTs may be structured to assure that cash flows in a single direction (to the issuer), though bidirectional cash flows (to the issuer and, in certain instances, back to the investor) may optionally be accommodated.

Additionally, it is an object of the present invention to provide investment opportunities which are distinctively agreeable to the risk/reward preferences of investors. Investors are anticipated to benefit from the risk/reward profile of Cash xPRTs that would otherwise be unavailable or available only subject to the severe limitations of the current synthetics market.

The invention anticipates a significant, market efficiency role for traders and includes analytical tools for traders to measure pricing effiency. The proposed invention resolves the many factors which limit Synthetic Cash xPRTs (bundles of listed and/or unlisted securities aggregated together to mimic the described features of a Cash xPRT) to, at best, a hypothetical market. The proposed Cash xPRT invention facilitates “original issuance” of integral securities by the corporate issuers of the underlying securities. Providing the means for corporate originations of Cash xPRTs (including the instrument itself as an integral whole with defined benefits and a means to facilitate underwritings of the instrument) potentially creates a large supply of high-integrity Cash xPRTs manufactured at low cost (avoiding the high cost of multiple spreads currently required to assemble Synthetic Cash xPRTs). Standardized, high integrity, original issue Cash xPRTs with minimal incidental costs (i.e. absent the high “assembly” costs currently incurred in synthetics due to multiple spreads) are conducive to establishing high volume public trading. In turn, original issue Cash xPRTs traded in high volume on public exchanges promise a far more competitively priced product than is now provided (if provided at all) in the synthetics market. A robust public market for original issue Cash xPRTs might naturally be anticipated to precipitate development of a competitive Synthetics Cash xPRT market since the natural hedge for an original issue Cash xPRT would be a Synthetic Cash xPRT: Alternatively, launch of broker-backed Synthetic Cash xPRTs with standardized features, high volume availability, and elimination of multiple spreads could precipitate development of a primary, original issue Cash xPRTs market. Whether volume emerges first in the synthetics (broker-backed) markets or the primary (issuer-backed markets), derivatives traders will benefit by providing liquidity, hedging and other market efficiency enhancing services, and the invention includes means to analyze the pricing of Cash xPRTs.

The invention includes a description of a valuable service which may be provided by an underwriter (broker) in the issuance of Cash xPRTs. An underwriter may assume certain risks inherent in Cash xPRTs for a price that will be agreeable to the issuer, the investor, and the underwriter. The invention discloses the mathematics governing the pricing of the underwriter's service including specifically:
1) A mathematical expression to relate the underwriters' risk to the terms of the security (a tool that facilitates structuring a security with terms amenable to underwriting),
2) A set of equations to define the underwriter's risk and reward in terms of exposure to a single options contract (a tool to facilitate the underwriter's decision on pricing his services and to allow an issuer to assess the reasonableness of an underwriter's fees),
3) A “three way” perspective set of formulas to evaluate the interrelationship of pricing and costs (a tool to allow the issuer to assess the pricing of the security using 3 separate theories of valuation).

The present invention's contribution to issuers, investors, traders, and underwriters through the issuance of a recognizably new class of securities with distinctive risk/reward characteristics is anticipated to increase overall financial market efficiency. Undervalued companies will have a new tool tailored to accommodate their financial needs, so their access to capital markets will be improved. The number of investors able to consider investment in an undervalued company will increase as will the size of their potential investments due to the special and arguably more attractive risk/reward profile of Cash xPRTs relative to existing, alternative investment vehicles. The structure of Cash xPRTs partitions risk in a manner conducive to assumption by underwriters of risks that neither issuer nor investor may wish to bear. The underwriter's identified and quantified risk reallocation role is a valuable service that is also in the public interest. A market for Cash xPRTs that conforms to certain described principles (in particular, see discussion of the “Transition Conversion Formula”, page 48) is anticipated to permit risk management activity by individual traders and hedgers that will further contribute to the depth, breadth, and liquidity of markets. All these factors together are anticipated to contribute to the robustness of financial markets and the improvement of capital allocation efficiency.

It is an object of the present invention to provide multiple benefits specifically to investors, brokerages, and derivatives traders through a distinctive security with a novel combination of standard and optional features and consequent unique risk/reward and liquidity characteristics for purposes of issuance and trading in the synthetics market (broker or third party backed securities markets).

It is an object of the present invention to provide multiple benefits specifically to corporations, investors, brokerages and derivatives traders through a distinctive security with a novel combination of standard and optional features that allows a corporation or other entity whose existing securities are undervalued to capitalize on that undervaluation without incurring debt and simultaneously provide investors, brokerages, and derivatives traders a novel and attractive investment and trading vehicle.

It is yet another object of the invention to provide multiple benefits specifically to corporations, investors, brokerages, and derivative s traders through creation of a business practice (“Cashless Buybacks”) consisting of a novel and distinctive security and its use as a medium of exchange in order to permit a corporation or other entity whose existing securities are undervalued to capitalize on that undervaluation without incurring debt or risking dilution while simultaneously providing investors, brokerages, and derivatives traders a novel and attractive investment and trading vehicle.

Still another object of the invention is to create a distinctive security with a novel combination of standard and optional features including, optionally, a Liquidation Value that is designed to facilitate securing an underwriter's guarantee that benefits investors through a reduction of risk, issuers through improved terms of capital access, and traders through access to unique trading vehicles.

Yet another object of the invention is to create a distinctive security with a liquidation value that lowers risk to investors and issuers.

Further, it is an object of the invention to provide a method of offering a security that allows a company to raise capital without diluting its equity position.

Still another object of the invention is to provide a security that does not change a company's leverage ratio.

Still another object of the invention is to provide issuers, investors, traders and underwriters tools to evaluate the pricing of the security and the pricing of underwriting services.

### BRIEF DESCRIPTION OF THE DRAWINGS

A further understanding of the present invention can be obtained by reference to a preferred model of transactions set forth by a drawing and illustrated by examples. Although the illustrated model is merely exemplary of transactions for carrying out the present invention, both the organization and arrangement of the invention, in general, together with further objectives and advantages thereof, may be more easily understood by reference to the drawing and illustrative examples. The drawing is not intended to limit the scope of this invention, which is set forth with particularity in the claims as appended or as subsequently amended, but merely to clarify and exemplify the invention.

For a more complete understanding of the present invention, reference is made to the drawings, in which:

FIG. 1 depicts the intrinsic value of the Cash xPRT in relation to the price of the underlying security.

FIG. 2 depicts the results of approximating the value of a Cash xPRTt by inspecting the marginal differential option premiums.

FIG. 3 depicts the results of approximating the value of a cash xPRT by comparing it to publicly available options.

FIG. 4 depicts the results of approximating the value of a Cash xPRT by using the theoretical value of a deconstructed Cash xPRT.

### DETAILED DESCRIPTION OF THE PREFERRED EMBODIMENT

As required, a detailed illustrative embodiment of the present invention is disclosed herein through an example, and application of the example, these are supplemented by a detailed description of possible outcome scenarios for the illustrated example. However, transactions in accordance with the present invention may be embodied in a wide variety of forms and modes, some of which may be quite different from those in the disclosed model of transactions. Consequently, the specific details disclosed herein are merely representative, yet in that regard, they are deemed to afford the best model of transactions for purposes of disclosure and to provide a basis for the claims herein which define the scope of the present invention. The following presents a detailed description of a preferred model of transactions (as well as some alternative models) of the present invention.

Definition of Terms

Because Cash xPRTs contain several unusual trading characteristics, as a prelude to the example description, a definition of terms is provided below. The definition of terms, when using specific examples, are all based upon the illustrative example that follows.
“Keep” (“K”): The return to the investor at the Target Price based on the intrinsic value IV at the Target Price Pt. Intrinsic value IV can be determined by 2 alternative methods at Pt: “Keep1” (“K1”) based on the Conversion Ratio CR the instant before the Target is met, or “Keep2” (“K2”) based on the “Conversion Option” the instant after the Target has been met. In our example, K1 and K2 are equal and both are referred to as the Keep.
Example: If the underlying security of a Cash xPRT is Stock, and the stock price rises from an initial value (“Now” or “Spot”) of $100.00 to a Target Price Pt of $145.00, and if the intrinsic value IV of the Cash xPRT at the $145.00 Target Price Pt is $124.00, then the Investor's Keep K is $124.00. Alternatively, Keep may be expressed, in this example, as 24.0%, or the “Minimum Upside Participation” percentage profit at the Target intrinsic value.
“Give Back” (“GB”): The decline (if any) in intrinsic value of a Cash xPRT between the “Transition Target” (“Cutback Target”, “CBt”) and the Target Price Pt. Note that in some instances it may be attractive to issue a Cash xPRT that increases in value in the Transition Range between CBt and Pt rather than decreases. In instances where the optional Cutback Target CBt and Transition range are absent and in which the Cash xPRT increases in value in the Transition Range, “Give Back” is the decline from the maximum intrinsic value below Target Price Pt to the intrinsic value at the Target Price Pt.
Example: (Same as above.) Assume the underlying security of a Cash xPRT is Stock, the Cutback Target CBt is $137.75, the Target Price Pt is $145.00, the Initial Conversion Ratio (“Lv1a”) is 1.160, and the Target Conversion Ratio (“Lv1b”) is 0.855. A Transition Conversion Formula is selected so that at its lower limit at Cutback Target CBt ($137.75) it produces a value for Conversion Ratio CR equal to the initial Leverage (1.160) and at its upper limit at Target Price Pt ($145.00) it produces a value for CR (0.8552) that provides an intrinsic value IV at Pt equal to Keep1 K1 ($124.00). Then the intrinsic value of the Cash xPRT at Cutback Target CBt ($137.75 equals $159.79:

$$\begin{matrix}IV at CBt = Lv1a * CBt \\ = 1.160 * \$137 .75 \\ = \$159 .79\end{matrix}$$
The intrinsic value IV of the Cash xPRT at Target Price Pt (Pt=$145.00) as determined by the Conversion Ratio CR equals $124.00:

$$\begin{matrix}IV at Pt = Lv1b * Pt \\ = 0.8552 * \$145 .00 \\ = \$124 .00\end{matrix}$$
And Give Back GB equals $35.79.

$$\begin{matrix}GB = ( IV at CBt ) - ( IV at Pt ) \\ = \$159 .79 - \$124 .00 \\ = \$35 .79 .\end{matrix}$$
“Initial Conversion Ratio” (“Lv1a”): The value of the Conversion Ratio (1.160) at the optional Cutback Target CBt ($137.75. In this example, the Initial Conversion Ratio is set equal to the initial Leverage Lv1a, and the terms Initial Conversion Ratio and Initial Leverage are used interchangeably.
“Initial Leverage” (“Lv1a”): The number of underlying securities a Cash xPRT is initially convertible into. In this example, the Initial Conversion Ratio is set equal to the initial Leverage Lv1a and the terms are used interchangeably.
Example: If the underlying security of a Cash xPRT is Stock, and the Cash xPRT is initially convertible into 1.160 shares of stock at expiration, then the Initial Leverage Lv1a is 1.160. Because it may be advantageous to set the Initial Conversion Ratio equal to the Leverage Lv1a (as in the given example), the terms Initial Leverage and Initial Conversion Ratio in such cases may be used interchangeably.
“Transition Conversion Formula”: The optional Transition Conversion Formula (or “Conversion Ratio Formula”) governs the value of the Conversion Ratio at expiration if the underlying security is between the optional Cutback Target CBt and Target Price Pt.
Example: (Same as above.) If the underlying security of a Cash xPRT is Stock, the Cutback Target CBt is $137.75, the Target Price is $145.00, Initial Leverage and Initial Conversion Ratio are both equal to Lv1a (1.160), and between the Cutback Target CBt and the Target Price Pt the Conversion Ratio declines to 0.8552 in order to generate Give Back GB equal to $35.79 and Keep1 K1 equal to $124.00, then one possible formula to achieve that result would be a linear value formula:
   CR=(839.80/AVGP)−4.9366
   Where:
      CR is the Conversion Ratio at expiration if the security is trading between Cutback Target CBt and Target Price Pt;
      AVGP is a measure of price such as a 10 day average closing price.
“Ratchet”: An optional feature whereby the Initial Conversion Ratio can change in only one direction. If the Stock price enters the Transition Range and/or exceeds the Trigger Price, but does so for an insufficient period of time to trigger Acceleration, a Ratchet feature allows the whereby the Transition Conversion Formula to operate in only one direction (for instance, only when the Stock rises but not when the Stock falls) so that the effects of the Conversion Formula are “one way”.
Example: (Same terms as above) If the Initial Conversion Ratio CR equals Initial Leverage Lv1a of 1.160 at a stock price of $137.75, and if the stock price rises to $145.00 (without triggering Acceleration) at which price the Transition Conversion Formula generates a Conversion Ratio CR equal to 0.8552, then, in the event the stock price subsequently declines, the Conversion Ratio will not rise but instead remain at 0.8552 if a Ratchet is in place.
“Target Conversion Ratio”: In instances where an optional Transition Target (Cutback Target CBt) is included, the value of the Conversion Ratio at the Target Price Pt.
Example: (Same as above.) If Initial Leverage and the Initial Conversion Ratio both equal Lv1a (1.160) but between Cutback Target CBt ($137.75) and Price Target Pt ($145.00) the Conversion Ratio CR is s subject to the formula below, then at the $145.00 Target Price Pt the Target Conversion Ratio equals 0.8552.

$$\begin{matrix}CR = ( 839.80 / AVGP ) - 4.9366 \\ = ( 839.80 / \$145 .00 ) - 4.9366 \\ = 0.8552\end{matrix}$$

Where:
   CR is the Conversion Ratio at expiration if the security is trading between Cutback Target CBt and Target Price Pt;
   AVGP is a measure of price such as a 10 day average closing price.
“Conversion Option” (“Acceleration Option”) Terms: The terms on the security into which the Cash xPRT is convertible if the Target Price is attained at Maturity (or earlier if the Option Conversion Feature includes Acceleration). Such terms could include Term, Premium, Strike Price, and Number of Shares (“Option Conversion Ratio”). Additionally, the terms may include a Liquidation Value for the Conversion Option.
Example: (Same as above.) The underlying security of a Cash xPRT is Stock, the Cutback Target Price CBt is $137.75, the Target Price Pt is $145.00, the Leverage and Initial Conversion Ratio both equal Lv1a (1.160), and between CBt and Pt the Conversion Ratio CR is subject to the Conversion Ratio Formula above that reduces the Target Conversion Ratio to 0.8552 at Pt. In this example, Conversion Option Terms are selected to produce a Conversion Option intrinsic value at Target Price Pt (“Keep 2”, “K2”) that is identical to the $124.00 intrinsic value based produced by the Conversion Ratio CR at Target Price Pt (“Keep 1”, “K1”). Numerous options would satisfy these conditions (including the condition that K2 equals K1), and, in any case, it is not mandatory that the intrinsic values be equal (it is not mandatory that the intrinsic value of K2 equals the intrinsic value of K1). Terms on the selected Conversion Option include: A 21-day Option (or Warrant or similar security) to purchase 1.2000 Shares (Lv2) for total consideration of $50.00 (“Strike” or alternatively expresses as “Strike per Share” “Strpsh” equal to $41.67) subject to a liquidation value of $100.00 (in lieu of exercise, the Conversion Option may be put back to the issuer for its Liquidation Value). Intrinsic Value IV of the selected Conversion Option at Target Price Pt has been designed to equal Keep K of $124.00 Conversion Option IV at Pt=Lv2*Pt−Strike

$$\begin{matrix}= 1.2000 * \$145 .00 - \$50 .00 \\ = \$124 .00\end{matrix}$$
“Liquidation Value”: Liquidation Value refers to an alternative, minimum guaranteed value, typically, but not necessarily, cash, for the Conversion Option. The Liquidation Value may include various terms, but, in any event, will apply to the Conversion Option after the Trigger Price has been attained.
“Acceleration”: Acceleration is an optional feature that, if included, may permit (or require) conversion prior to Maturity. For instance, the Conversion Option Terms could become effective immediately upon reaching Performance Target Pt, some period of time after reaching Performance Target Pt, at Maturity after reaching Performance Target Pt, at Maturity but only if the stock is still above Performance Target Pt, or Acceleration could be triggered by some alternative conditions.
“Transition Conversion Option Terms”: An optional feature applicable at Maturity (also potentially applicable under other defined conditions such as Acceleration). If included, then terms are provided for an intermediate option (Transition Conversion Option) whose terms may, for instance, be a function of the Conversion Ratio Formula (page 28). If a Transition Conversion Option feature is included, then, under defined circumstances, if the Stock price is below Performance Target Pt, in lieu of converting in accordance with the Conversion Ratio formula, an optional or mandatory conversion may be governed by the Transition Conversion Option.
Example: (Same terms as above) The underlying security of a Cash xPRT is Stock, the Cutback Target Price CBt is $137.75, the Target Price Pt is $145.00, the Leverage and Initial Conversion Ratio both equal Lv1a (1.160), and between CBt and Pt the Conversion Ratio CR is subject to the Conversion Ratio Formula (page 28) that reduces the Target Conversion Ratio to 0.8552 at Performance Target Pt. Acceleration has not been triggered, and, at Maturity, the stock is trading at a price below Performance Target Pt. Nonetheless, in lieu of automatic conversion into a number of shares dictated by the Conversion Ratio, provision may be made for conversion into a Transition Conversion Option, for instance with terms similar to a modified version of the Acceleration Option.

Other terms used in the present application are well known. Consequently, a definition thereof is deemed unnecessary. By way of non-limiting examples, the terms trigger price and target price are well known terms in the art.

A Cash xPRTs offering, either directly as a corporate obligation (“issuer-backed”) or as a derivative instrument backed by a party other than “Target” (“broker-backed”), is a valuable financial instrument because of its features and its applications. The instrument consists of:
1) An underlying Stock
2) An Initial Conversion Ratio
3) A Performance Target Price (“Trigger Price” or “Target Price”)
4) A Conversion Option with Terms
   Cash xPRTs also may include:
1) A Transition Target Price (“Transition Target” or “Cutback Target”),
2) A Transition Range
3) A Transition Conversion Formula
4) A “Ratchet” feature on the Transition Conversion Formula
5) A Transition Option Conversion with Terms
6) Acceleration terms
7) Liquidation Value 8) Other features.

These features can be combined to produce distinctive trading characteristics for Cash xPRTs including specifically combinations that apply with particular relevance to transactions that capitalize on underpriced securities such as Cashless Buybacks. Distinctive features of Cash xPRTs structured to apply to underpriced securities include, among others, Keep (also referred to as “Minimum Upside Participation”), Giveback, Initial Leverage (Lv1a) and Final Leverage (Lv2). The combination of features of Cash xPRTs can be arranged to permit the potential issuance of stock at a premium price while ensuring, if necessary, positive upside returns for all parties. From the issuer's perspective, Cash xPRTs also allow the possibility of ensuring the flow of cash in a single direction (from the investor to the issuer), and, if desired, avoid any of the features of debt securities. The combination of features is anticipated to appeal to a number of issuers including, in particular, undervalued entities with limited cash resources.

To illustrate the fundamental design of Cash xPRTs, consider the example situation of one particular model for the invention. If an underlying Security's current (“Spot”) price is $100.00, terms for a Cash xPRT could include:
1) Term of 3 years
2) Initial Conversion Ratio Lv1a equal to 1.160 (producing intrinsic value at Spot of $116.00)
3) Cutback Target CBt equal to $137.75 so that, through operation of Lv1a, intrinsic value at CBt equals $159.79)
4) Performance Target Pt equal to $145.00
5) A Conversion Ratio formula that generates Lv1b (Conversion Ratio Cr at Performance Target Pt) equal to 0.8552 so that through operation of Lv1b intrinsic value K1 at Performance Target Pt equals $124.00. Accordingly:
   CR=(839.80/AVGP)−4.9366
Where:
   CR is the Conversion Ratio at expiration if the security is trading between Cutback Target CBt and Target Price Pt;
   AVGP is a measure of price such as a 10 day average closing price.
6) A Conversion Option (a 21 day option to buy 1.2000 shares of the underlying Security for total consideration of $50.00) with terms set to create K2 (the option's intrinsic value at Performance Target Pt) equal to $124.00 (in this example, K2's value is set equal to the value of K1) and with Lv2 (the post Acceleration, leveraged exposure to the underlying Security at prices above the Conversion Option's $41.67 strike price per share) equal to 1.2000. For instance, in this example, post Acceleration, the package of securities' intrinsic value fluctuations will be in direct proportion to 1.2000 shares of the underlying Security when the underlying Security is at a price level equal to or above the Conversion Option's $41.67 strike price per share. The Conversion Option may have additional terms, for instance, an Underwriter's Guarantee whereby the Conversion Option holder may elect to put the Conversion Option to the Company (or an Underwriter) for a Liquidation Value (for instance, $100.00 cash) in lieu of exercise.

In the illustrated example, the chosen Conversion Ratio Formula (Transition Formula) governing conversion within the Transition Range is a constrained linear value function. That need not be the case, but a constrained linear value function Transition Range Conversion Formula is preferred. In particular, before consideration of various important optional provisions (including “Ratchet”, “Liquidation Value”, and “Acceleration” features and terms among others), a Conversion Ratio Formula that is a constrained linear value function allows the Cash xPRT, in theory, to be “deconstructed” into relatively few component parts. Because the Conversion Ratio Formula of the example Cash xPRT does conform to a constrained linear value function, the example case can be deconstructed into just 5 key components:
1) 1.0000 “Knock out” dividend and voting right with 3 year initial term and a $145.00 “knock-out” trigger.
2) 1.1600 $0.00—strike European “knock out” calls with optional ratchet and 3 year initial term
3) 1.2000 $41.67—strike “AAKIC” (American accelerating “knock in” calls) with optional Liquidation Rights and optional Underwriter Guarantee, $145.00 “knock-in” trigger, 3 year initial term, 21 day term post “knock in”.
4) −6.0966 $137.75—strike European “knock out” calls with a $145.00 “knock-out” trigger, 3 year initial term.
5) 6.1366 $145.00—strike European “knock out” calls with a $145.00 “knock-out” trigger.

Note that this theoretical “equivalence” is before various other considerations including: 1) As the optional Transition Range approaches zero, the theoretical number of options required to duplicate the intrinsic value of a Cash xPRT becomes infinite. If the Transition Range Conversion Formula deviates from a linear value function, the required “equivalent” set of options would be more complex or impossible. If the Cash xPRT included a “Ratchet” feature, the equivalent options would need to include an equivalent “intrinsic value ratchet” or effectively similar variable option feature (which, to the applicant's knowledge, is not a feature currently available in the public or private options markets). “Acceleration”, “Liquidation Value, and “Transition Option Conversion” terms are additional optional features that complicate any discussion of the “equivalency” of Cash xPRTs to a package of standard options.

Table 1 (below) summarizes the intrinsic value (“IV”) of the example Cash xPRT at various price points and illustrates the Effective Conversion Ratio CRf at any price P (CRf=IV/P). Within the Transition Range, the example CRf equals CR and may be expressed by a “linear value” Conversion Formula” discussed below (page 36).

TABLE 1
INTRINSIC VALUE OF EXAMPLE CASH xPRT

| | Effective | |
|---|---|---|
| | Conversion | Cash xPRT |
| Stock | Ratio | Intrinsic |
| Price | CRf* | Value (IV) |
| $86.21 | 1.160 | $100.00* |
| $100.00 | 1.160 | $116.00* |
| $137.75 | 1.160 | $159.79 |
| $140.86 | 1.026 | $144.46 |
| $145.00 | 0.855 | $124.00 |
| $150.00 | 0.867 | $130.00* |
| $174.83 | 0.914 | $159.79* |
| $250.00 | 1.000 | $250.00* |
| $300.00 | 1.033 | $310.00* |

Where:
   P is the stock price that determines the Conversion Ratio
   CRf is the Effective Conversion Ratio
   Cutback Target CBt equals $137.75
   Performanc Target Pt equals $145.00
   Conversion Ratio Formula: CR=(839.80/P)−4.9366

Then:

| | |
|---|---|
| If: P <= $137.75 | CRf = 1.160*P |
| If: $137.75 < P < $145.00 | CRf = (839.80/P) − 4.9366 |
| If: P >= $145.00 | CRf = Option IV/P** |

*In this example Initial Leverage is set equal to the initial Conversion Ratio Lv1a so that at any price P below Cutback Target CBt ($137.75) the effective Conversion Ratio CRf equals 1.160 (i.e. the same value as both the initial Conversion Ratio Lv1a and Initial Leverage).
**At any price P above Performance Target Pt ($145.00), the effective Conversion Ratio CRf is determined by the ratio of the Conversion Option's intrinsic value (“Option's IV”) divided by P (the Stock's price); the Option's IV is a function of its terms ($50.00 total premium for purchase of 1.2000 shares). For example, at P equals $250.00, then CRf equals 1.000:

$$\begin{matrix}Effective CR = Option IV / P \\ = [ ( Leverage2 * P ) - Strike ] / P \\ = [ ( 1.200 * \$250 .00 ) - \$50 .00 ] / \$250 .00 \\ = 1.000\end{matrix}$$

An optional feature is the form of the Transition Conversion Formula (also called the “Conversion Ratio Formula”). Theoretically, Conversion Ratio CR within the example transition range between Cutback Target CBt at $137.75 and Target Price Pt at $145.00 might be defined by an arbitrary formula. However, a constrained linear value formula has particular merit. Terms for a constrained linear value formula can be derived by noting, for instance, in the example case that:
1) Each Cash xPRT is “equivalent” to 1.160 (initial Leverage Lv1a) shares of the underlying security up to the $137.75 Cutback Price CBt.
2) The “Initial Conversion Ratio” CR at the $137.75 Cutback Price CBt in the example case has been selected to equal to the initial Leverage Lv1a (1.160).
3) Therefore, the intrinsic value of each Cash xPRT at the Cutback Target CBt equals $159.79, the initial Leverage times CBt:

$$\begin{matrix}IV at CBt = Lv1a * CBt \\ = 1.160 * \$137 .75 \\ = \$159 .79\end{matrix}$$
4) Keep1 (K1, the Cash xPRTs intrinsic value at Performance Target Pt based upon application of the Conversion Ratio CR), is selected to equal $124.00. Therefore, the required Conversion Ratio at Pt, Leverage 1b (“Lv1b”), must equal 0.8552:

$$\begin{matrix}CR at Pt = Lv1b \\ IV at Pt = Lv1b * Pt \\ Lv1b = ( IV at Pt ) / Pt \\ = \$124 .00 / \$145 .00 \\ = 0.8552 \\ CR at Pt = 0.8552\end{matrix}$$
5) Give Back GB (the intrinsic value given up between Cutback Target CBt and Performance Target Pt) equals $35.79:

$$\begin{matrix}GB = ( IV at CBt ) - ( IV at Pt ) \\ = \$159 .79 - \$124 .00 \\ = \$35 .79\end{matrix}$$
6) Define SC (“short calls”) as the number of theoretical short calls required at strike price CBt to create the Cash xPRT's Give Back (GB) and Keep (K) structure. In the current example, SC must equal 6.0966:

$$\begin{matrix}SC = Lv1a + GB / ( Pt - CBt ) \\ = 1.160 + \$35 .79 / ( \$145 .00 - \$137 .75 ) \\ = 6.0966\end{matrix}$$
7) If “x” is price and Lv1a the initial leverage at Cutback Target CBt, then a general case linear value Conversion Ratio Formula can be defined for prices in the range between CBt and Pt as:

$$\begin{matrix}CR = [ ( IV at CBt ) - SC * ( x - CBt ) ] / x \\ = [ Lv1a * x - SC * x + SC * CBt ] / x \\ = ( Lv1a - SC ) + ( SC * CBt ) / x\end{matrix}$$
In the current example:

$$\begin{matrix}CR = ( Lv1a - SC ) + ( SC * CBt ) / x \\ = ( 1.160 - 6.0966 ) + ( 6.0966 * \$137 .75 / x \\ = - 4.9366 + 839.80 / x\end{matrix}$$

In the example case, at its lower boundary Cutback Target CBt ($137.75), the described linear value Conversion Ratio Formula is crafted to produce an Initial CR that generates the same intrinsic value for the Cash xPRT as would be obtained using the initial Leverage factor Lv1a, i.e. the described linear value Conversion Ratio Formula generates a value for CR at price CBt equal to Lv1a (1.160) and Cash xPRT intrinsic value of $159.79. At its upper boundary at Target Price Pt ($145.00), the Transition Formula is crafted to produce the same Cash xPRT intrinsic value “Keep1” or “K1” ($124.00) as would be obtained upon acceleration of the Conversion Option (“Keep2”, “K2”). These additional conditions (“constraints”) included for convenience in the derived Linear Value Conversion Ratio Formula can be expressed as:
CR at CBt=Lv1a
K1=K2

Advantages are enjoyed by choosing a Transition Conversion Formula that conforms to the conditions of the example (a linear value equation generating CR values constrained so 1) At Cutback Target CBt CR equals initial leverage Lv1a and 2) At Performance Target Pt K1=K2).

First, with regard to the advantages of a linear value formula, a linear value function provides the benefit of being approximated by standard options. Accordingly, a linear value Conversion Ratio Formula provides a simple interface for hedging activity. The ability to hedge against Cash xPRT fluctuations is of general benefit to market efficiency, and provision of a simple hedging interface can contribute to active derivative hedging with consequent improved liquidity and orderly price adjustments. In the event of an underwritten offering, the risk assumed by the underwriter will in part mirror the terms of the Conversion Ratio Formula. Because a linear value Conversion Ratio can be replicated with standard options, it simplifies an underwriting. Underwriting expenses can be minimized if risk is minimized, and a structure that can be hedged with standard options greatly simplifies underwriting risk.

With regard to the advantages enjoyed by providing the example constraints (at Cutback Target CBt the Conversion Ratio CR equals initial leverage Lv1a and at Performance Target Pt K1 equals K2), these constraints are inducements to orderly trading since they eliminate any discontinuity in the intrinsic value of the Cash xPRT. For instance, at prices below the Cutback Target CBt, the Cash xPRT's intrinsic value is governed by the Initial Leverage Lv1a; in the Transition Range between Cutback Target CBt and Performance Target Pt, intrinsic value is governed by the Conversion Ratio Formula (until Acceleration); at prices above Target Price Pt, intrinsic value is governed by the Conversion Option. The described constraints assure a continuous intrinsic value function with no gaps in intrinsic value as price moves from one domain to the next. The claimed form allows for modification of the constraints. For instance, to the extent that total value continuity is an objective (as opposed to intrinsic value), it may be beneficial to deviate from the described constraints. For example, the time value of the Conversion Option (and the theoretical options used to create the Transition Range, if any) may cause a significant divergence between intrinsic value and actual value, and for this reason or in order to achieve other objectives (such as inducements to exercise), constraint modifications are anticipated. Deriving a constrained linear value Conversion Ratio Formula in cases where the described constraints are adjusted to accommodate additional factors is straightforward once the new, end point conditions are described in light of the specific additional objectives of a given Cash xPRT.

The example case illustrates the applicability of Cash xPRTs to underwritten Cashless Buybacks, and illustrative terms appropriate for that particular transaction have been selected. To achieve other objectives with a Cash xPRT, other terms might be appropriate include an alternative form of Transition Conversion Formula, alternative (or modified) constraints, and/or additional Transition Conversion features. Or, even in the case of an underwritten Cashless Buyback, modifications may be useful in practice despite any consequent reduction in the simplicity of hedging or incentives to orderly markets. For instance, additional, optional features governing terms of conversion within the Transition Range may include a “Ratchet” feature and/or a Transition Option Conversion feature (including rules for a Transition Conversion Ratio, Transition Strike Price, and Transition Option Conversion Term analogous to the Conversion Option terms).

The present example excludes Ratchet and Transition Range Option Conversion features, though both these may have attractions in specific Cash xPRT structures. The application of optional Acceleration features, however, in practice, is a consideration in structuring the Conversion Ratio Formula to balance various tradeoffs including, among others, the exigencies of simplicity, orderly trading, and conformance to natural hedges, and additional features are anticipated to be a common element of Acceleration terms.

For instance, by way of illustration, if Acceleration is permitted, then, when the common shares trade at or above the Performance Target Price Pt in sufficient volume for a sufficient period, the Option Conversion feature may immediately take effect. Acceleration in combination with other optional features may allow (or require) early conversion at the current (or a defined) alternative Conversion Ratio CR. The application of some aspects of an Acceleration feature in conjunction with various other optional features such as Liquidation Value (including Binary Conversion Right) may, upon consideration, suggest deviation from the described constrained, linear value Transition Range Conversion Formula is warranted. Or, variations in the Acceleration features and/or a Transition Range Conversion Formula that deviates from the described constrained, linear value formula could be to serve the purpose of providing an incentive to convert for cash rather stock (or vice versa).

Cash xPRT Pricing Tools

The use of Cash xPRTs (including Cashless Buybacks and Underwritten Cashless Buybacks™) depends upon the Issuer and Buyer (and, if utilized, underwriter) understanding the instrument and having tools to correctly price the instrument (and, if utilized, to price the services of an Underwriter). Because the package of securities embedded in a Cash xPRT™ is “exotic”, and because “issuer-backed” options are, at best, rare (options are typically backed by securities houses, not the underlying issuer), and because inclusion of an underwriter adds an additional variable, the pricing of Cash xPRTs (and, particularly, the pricing of Underwritten Cashless Buyback™) poses difficulties. To address pricing, the described invention includes two sets of tools.

The first tool is a pricing tool consisting of a “three way” method of evaluating a Cashless Buyback™ to assure reasonable pricing.
i. Inspection of the implied marginal differential price of the embedded calls
ii. Inspection of risk/reward of a Cash xPRT relative to public options.
iii. Inspection of the probability theory based value of the theoretical, deconstructed component parts of the Cash xPRT.
i. A Cash xPRT constructed in conformance with the example above can be evaluated by looking at the theoretical marginal differential price of the embedded options. Using the hypothetical values from the above example, and assigning an estimated price PRcbt for one of the embedded options (in this example, $5.50 PRcbt, where PRcbt is the price for the options whose strike price equals CBt), and an “exchange incentive” (12.0% in this example), the price of the remaining options will be determined (in this example, $4.81 PRpt where PRpt is the price for the optins whose strike price equals Pt). Inspection of the difference in option prices divided by the difference in strike prices produces a value that is referred to as the marginal differential price of the options (“MDiff”). In this case:

$$\begin{matrix}MDiff = ( PRcbt - PRpt ) / ( CBt - Pt ) \\ = ( \$5 .50 - \$4 .81 ) / ( \$137 .75 - \$145 .00 ) \\ = - \$0 .09\end{matrix}$$

Because a Cash xPRT can be manufactured from “whole cloth” by an Issuer without constraints imposed by theoretical pricing of component parts, and because component parts differ significantly from publicly available options, and because the combination of the component parts and the circumstances of the issuer (quality, prospects) require consideration, the marginal differential price of the embedded calls does not need to equal a particular value. However, applying this number to the Cash xPRT provides a perspective on the pricing that is useful to determining the structure's attractiveness to Issuer, Investor, Traders, and Underwriter.
ii. Regardless of whether public options exist on the securities of a proposed Cash xPRT issuer, a matrix of expected option prices can be produced by inspecting the volatility of the Issuer's securities. By taking the actual or theoretical standard option prices of the issuer with maturities similar to the proposed Cash xPRT, key features of the Cash xPRT can be assessed for attractiveness relative to public market alternatives. In particular, public options with strike prices equal to Spot and Target can be used to evaluate their maximum upside, return at Spot, and downside protection (decline in the security before returns become negative). The consideration is made on a pretax and after tax basis after allowance for various tax regulations including regulations on straddles. Because of the unique characteristics of Cash xPRTs (including the supply of liquid securities in quantities and with backing that cannot be found in the public markets), the application of this tool is just an additional perspective on pricing issues.
iii. The third pricing tool to value a Cash xPRT uses the theoretical value of a deconstructed Cash xPRT. Using volatility, risk free interest rates, and risk premiums, the value of the theoretical components (which can be limited to 5 if a constrained, linear value Conversion Formula is used as in the example) of the Cash xPRT can be determined. Value is determined first by considering the probability of the Target not being reached and the contingent probability in that case that the price will be within the transition range. Then, given the remaining contingent probability that the target is achieved, the value contribution is calculated based on the probability of the Conversion Warrant's exercise and, if offered, the value contribution of the Warrant due to the contingent probability of acceptance of cash Liquidation Value or Binary Conversion rights. Based on the term and features of the Conversion Warrant, the volatility of the underlying security, and other variables (including independent variables such as interest rates and market volatility plus dependent variables such as the feedback impact of Warrant exercise on volatility), an adjustment to value is made based on the volatility value of the Conversion Warrant.

The second tool is a formula to express underwriting risk as function of the all the major independent variables that structure a Cash xPRT and determine its value characteristics. Underwriter's risk is a direct function of both the percentage gain from the spot price to the target price and the percentage the stock must fall from the target price to the liquidation election price.
Underwriter's Risk (Ru) can therefore be expressed as:
   Ru=f(Pb(T)*CPb(Pux)*U)
   Where Pb(T) is the probability of attaining a target price, U is the amount underwritten, and CPb(Pux) is the contingent probability that, having attained Target price, the Security Price will fall to the Underwriter Exposure price (Pux), the price at which the Underwriter becomes at risk if investors elect Liquidation in lieu of exercise.
Restating the probability terms of the function as a ratio that is equivalent to an out of the money option:
   Ru=f(Pux/Target)
   Where: Pux/Target is the figure of merit
In the example case, the underwriter guarantees 1) The Investor may elect to receive a Liquidation Value (Lq which, in this example, is chosen to equal the initial Spot value) by tendering his Conversion Options to the underwriter, in which case 2) The underwriter will exercise the Conversion Warrant for a price (Strike) to purchase a number of shares equal to Lv2 (Leverage 2).
Where Spot (Now) is the current spot price, T is the Target index (T=Target/Spot), and Keep2 (K2) is the intrinsic value of the Conversion Option at Target Pt, then Strike may be expressed as:

$$\begin{matrix}Strike = Lv2 * Target - Keep2 \\ = Lv2 * ( Spot * T ) - ( Spot * K2 ) \\ = Spot * ( Lv2 * T - K2 )\end{matrix}$$
In the current example where Liquidation Value Lq equals the current price Spot, then Pux, the effective stock price per share which the underwriter will pay in the event it is called upon to fulfill its guarantee can be stated as:

$$\begin{matrix}Pux = ( Lq + Strike ) / Lv2 \\ = ( Spot + Strike ) / Lv2\end{matrix}$$
Substituting for Strike:
   Pux=[Spot+Spot*(Lv2*T−K2)]/Lv2
To obtain figure of merit Pux/Target, divide both sides by Target (expressing Target as Spot*T on the equation's right side):

$$\begin{matrix}Pux / Target = [ ( Spot + Spot * Lv2 * T - Spot * K2 ) / Lv2 ] / ( Spot * T ) \\ = ( 1 + Lv2 * T - K2 ) / ( Lv2 * T ) \\ = 1 / ( Lv2 * T ) + 1 - K2 / ( Lv2 * T ) \\ = [ ( 1 - K2 ) / ( Lv2 * T ) ] + 1\end{matrix}$$
In the example case:

$$\begin{matrix}Pux / Target = [ ( 1 - K2 ) / ( Lv2 * T ) ] + 1 \\ = [ ( 1 - 1.240 ) / ( 1.2000 * 1.4500 ) ] + 1 \\ = 0.8621\end{matrix}$$

For reference, this equation that translates the principal structural terms of a Cash xPRT (Keep, Leverage at Pt, Target) into the principal risk element for a underwriter (Pux/Target, a contingent option liability) shall be referred to as the Underwritten Risk Equation.

Use of the pricing tool in combination with the underwriting risk tool facilitates coordinating rapid analysis of feasible structures with the related cost of underwriting services (or, absent an underwriter, the cost of an issuer self insuring through hedging).

Cash Xprt—Application of Example Case

Suppose the example Cash xPRT is utilized by example company Widgco Inc. to execute a Cashless Buyback. The company's Spot price is $100.00, shares outstanding equal 100.000 million. The company offers to exchange 1.00 Cash xPRTs for 1.00 outstanding share for up to a maximum of 35.0 million shares (35.0% of the outstanding shares). The Cutback Target Price CBt is $137.75 and the Performance Target Price Pt is $145.00. Minimum Upside Participation is set at 24.0% (Keep is $124.00, the Cash xPRT's intrinsic value at Performance Target Pt). The Cash xPRTs have a term of 3 years, at which point each Cash xPRT converts in accordance with the terms of the Conversion Ratio, or, if applicable, the Conversion Option (alternatively referred to as a “Warrant”). In this example, the initial Conversion Ratio CR and initial Leverage Lv1 a both equal 1.160, the Conversion Ration CR's maximum value. CR is governed by a Transition Conversion Formula that conforms to a constrained linear value form (as discussed on page 28). As a result of the Transition Conversion Formula, the Conversion Ratio CR reaches a minimum value of 0.855 at Performance Target Pt ($145.00) to generate intrinsic value (Keep1, K1) of $124.00.

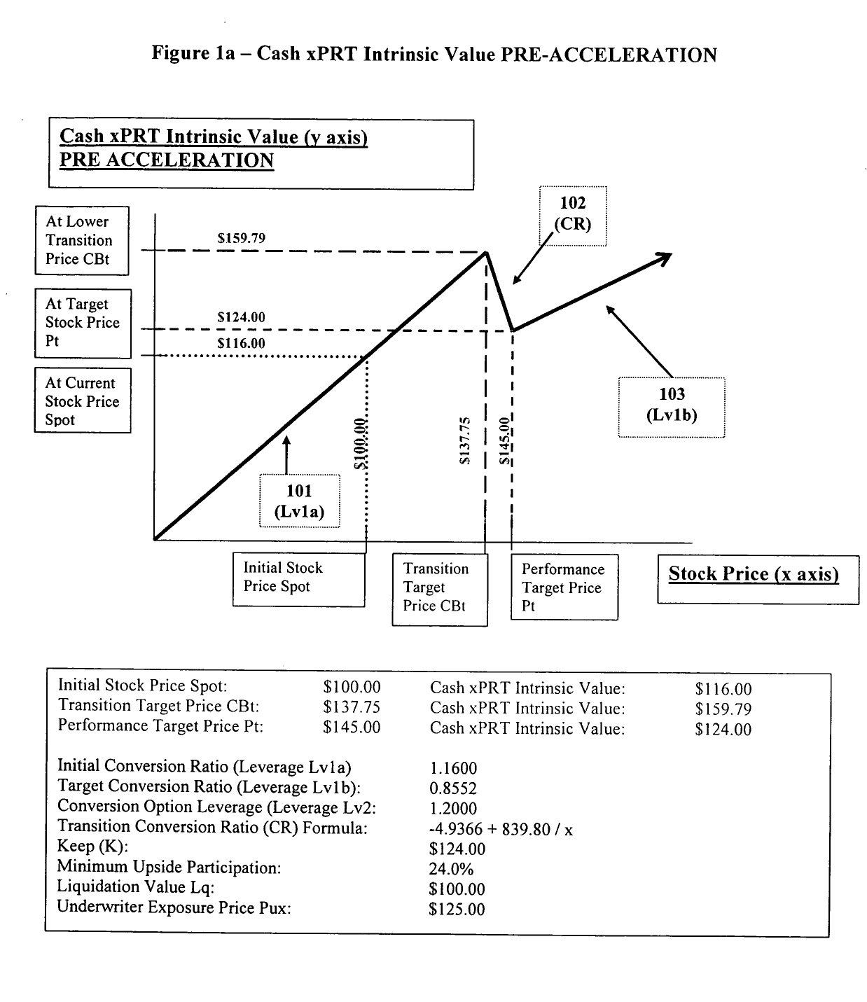

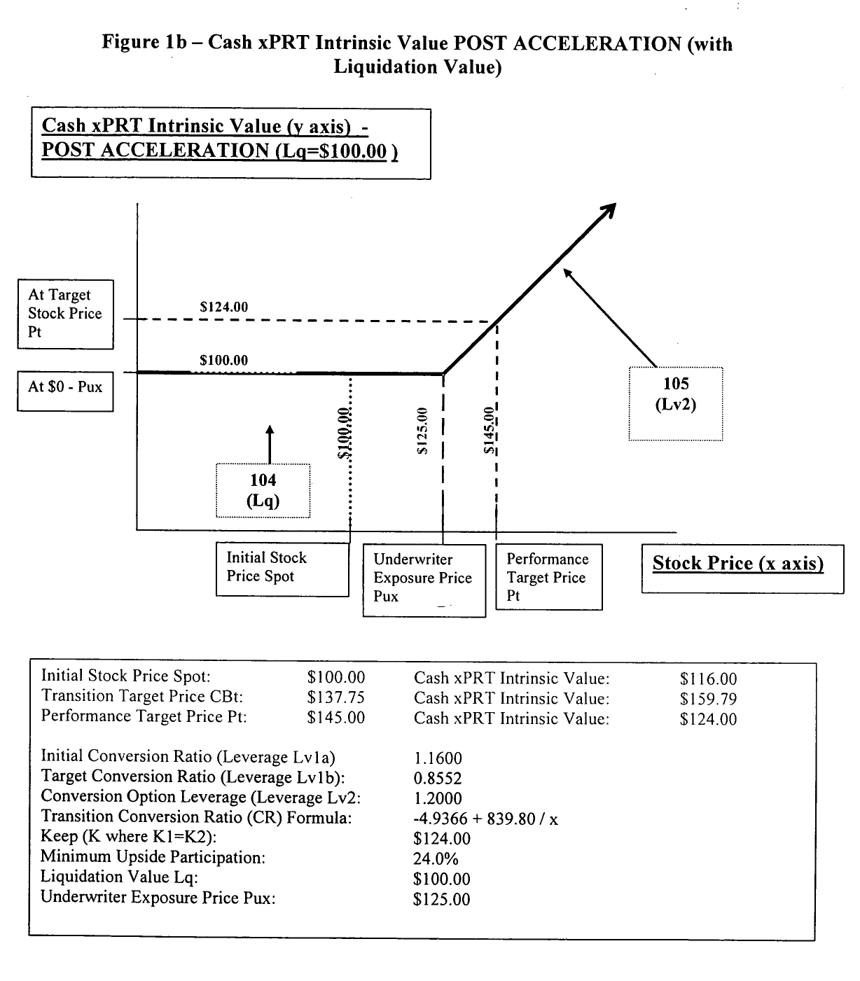

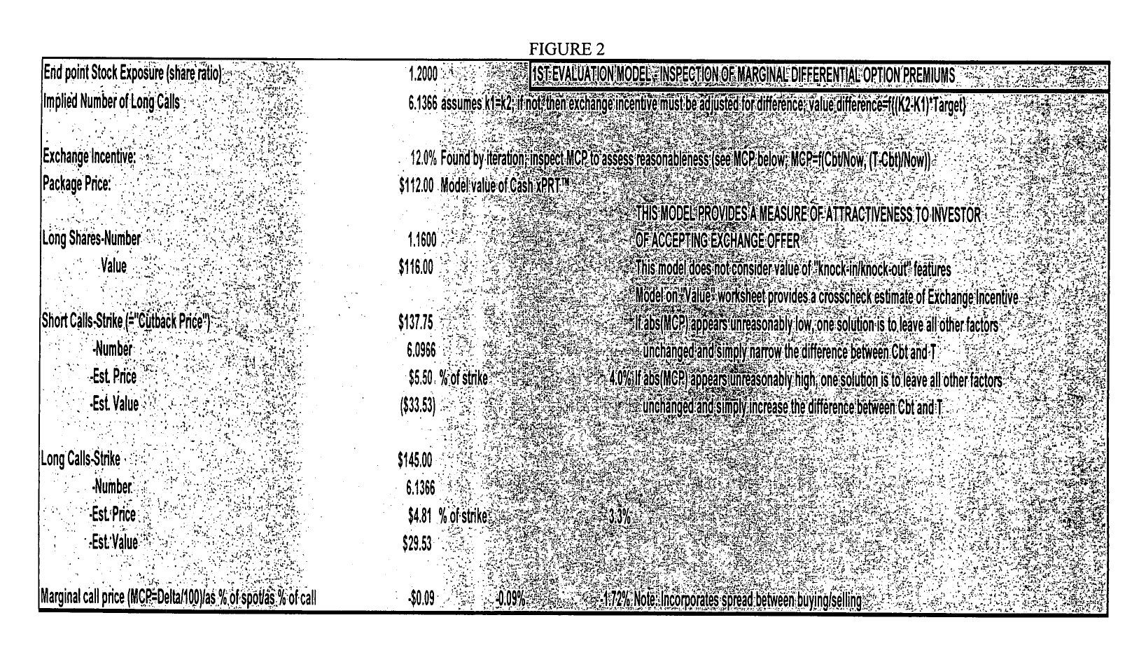

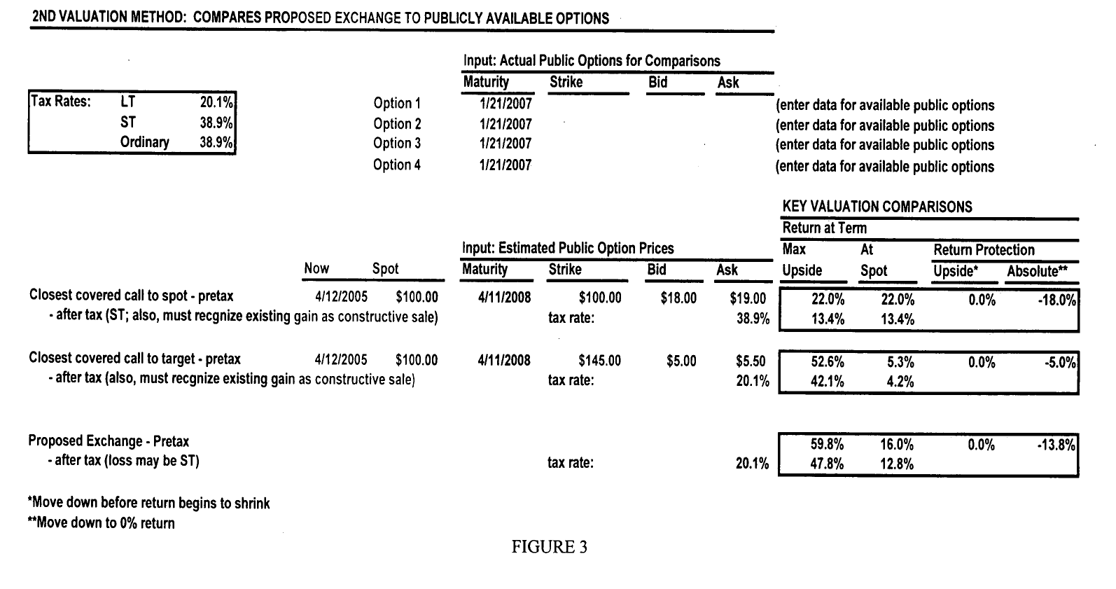

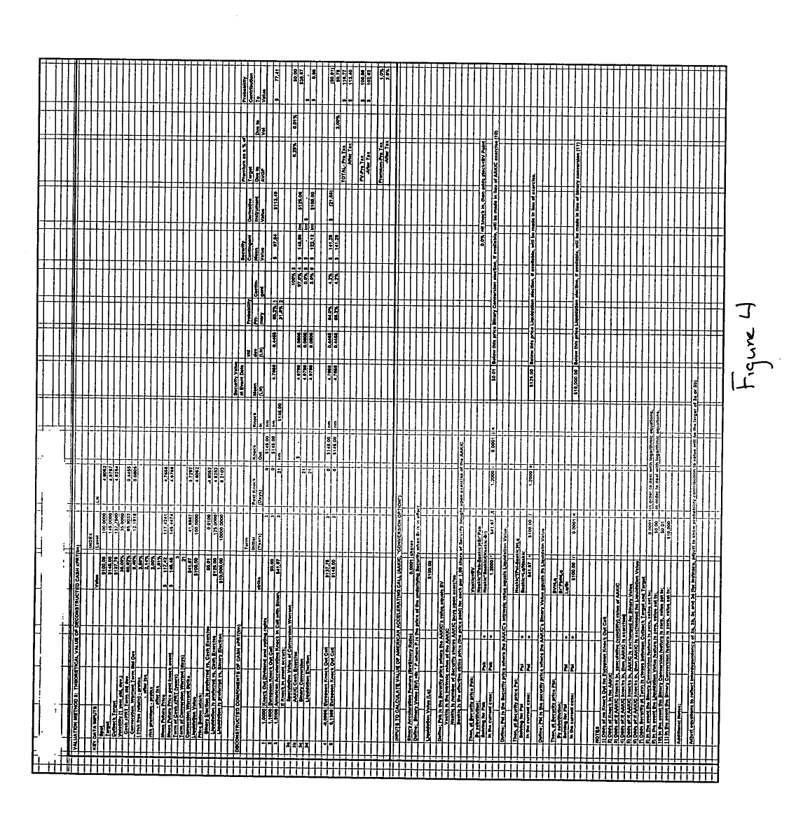

Referring now to the drawing in greater detail, FIG. 1a illustrates the intrinsic value of the Cash xPRT in relation to the price of the underlying stock for the illustrative model before Acceleration is Triggered. If the stock price is less than or equal to the $137.75 Cutback Target CBt at maturity, then each Cash xPRT converts into 1.160 (Lv1a) commons shares, producing the return illustrated by line 101. If the stock price is greater than Target Pt $145.00 but has not triggered Acceleration, then the trading of each Cash xPRT will be determined by price of the stock time the minimum Conversion Ratio (CR of 0.855). If the stock price falls within the Transition Range of $137.75−$145.00 at maturity, then intrinsic value conversion is defined by the Conversion Formula (Conversion Ratio CR=−4.9366+839.80/x where x is the Stock price at Maturity).

FIG. 1b illustrates the intrinsic value of the Cash xPRT in relation to the price of the underlying stock for the illustrative model after Acceleration is Triggered (it includes the optional feature of a Liquidation Value equal to $100.00). Upon Acceleration, the Cash xPT becomes a Conversion Option (a 21 day option to buy 1.2000 shares of the underlying Security for total consideration of $50.00). In the example case, at any price below the to $125.00 Underwriter Exposure price Pux, the Cash xPRT (now a Conversion Option) trades at an intrinsic value equal to the $100.00 Liquidation Value. At any higher price, it trades at the intrinsic value of the Conversion Option.

Example Case—Outcomes

In the described example, on or before maturity, one of three conversion scenarios will occur:
1) If at Maturity or earlier the stock price exceeds the $145.00 Performance Target Pt (“Trigger Price”), Acceleration immediately converts the Cash xPRT into a Conversion Option (“Warrant”). The Conversion Option is a 21 day option to buy 1.2000 shares of the underlying Security for total consideration of $50.00. The Conversion Option at the Performance Target Pt has intrinsic value IV equal to Keep2 (K2) with K2 selected to equal $124.00. The Warrant i) May be exercised, ii) May not be exercised, iii) May have exercise guaranteed by an Underwriter.
2) If the Company's stock price never exceeds the $145.00 Performance Target Pt and at Maturity the Company's stock price is less than or equal to the $137.75 Cutback Target Price CBt, then the Cash xPRT converts at Maturity into 1.160 common shares in accordance with initial Leverage 1 a (Lv1a; in this example, Lv1a equals the initial Conversion Ratio).
3) If the at Maturity the Company's stock price is between the $137.75 Cutback Target CBt and the $145.00 Performance Target Pt, then the Cash xPRT converts into a number of underlying shares (a minimum of 0.855 shares, a maximum of 1.160 shares) determined by the Transition Conversion Formula (Conversion Ratio CR=−4.9366+839.80/x where x is the Stock price at Maturity).

Note: In the following discussion, the terms “warrant” and “option” are used interchangeably in reference to the Conversion Option. The selection of a warrant or an option as the conversion security is a matter of convenience at the discretion of the issuer at the time of the offering and is dependent in part upon the respective listing and regulatory requirements of the two instruments. The preferred mode of operation would be to have the Conversion Option, whether a warrant or option, listed to trade on a public exchange with trading commencing immediately upon Acceleration and continuing until exercise or expiration at the end of the Conversion Option's Term, in this example, a term of 21 days.
1) Scenario 1—Acceleration at $145.00 Target Price Pt: Acceleration occurs when stock trades at or above $145.00 Performance Target Price Pt within the 3 year Target Timeframe.
Result: Each Cash xPRT converts into a Warrant to purchase 1.2000 shares (the Acceleration Option Conversion terms) of stock for a purchase price (Warrant Premium) equal to total consideration of $50.00 (i.e. a purchase price or “strike price per share” equal to $41.67).
After the Cash xPRT converts into a Warrant, there are 3 variations:
   i) Warrant exercised. The Warrant is exercised because the stock price is above the Option's $41.67 per share exercise price at the conclusion of the Warrant's 21 day term. As a result of the exercise of the Warrant, the issuer will collect $1,750 million (consideration of $50.00 for each of the 35.0 million Cash xPRTs issued).
   Analysis—Scenario 1, Variation i (Acceleration Plus Warrant Exercise)
   Issuer: The Company effectively sells shares at $250.00 apiece receiving $1,750 million consideration for sale of 7.0 million net new shares despite the fact that its stock price need never trade significantly over $145.00.
   The Company Receives $1,750 million consideration ($50.00 for each of the 35.0 million Cash xPRTs issued). The 35.0 million Cash xPRTs issued convert into 35.0 million Warrants, and these are converted into 42.0 million shares through payment of $1,750 million cash consideration. Net new shares issued by the Company amount to 7.0 million (35.0 million shares bought back through exchange, 42.0 million shares issued upon Warrant exercise, leaving a 7.0 million share net increase).
   Investor: Earns a minimum return of 24.0%. Investor begins with $100.00 (the value of 1.00 shares of stock at the time of the Cash xPRT exchange offer). At Acceleration, the Warrant achieves a minimum value at least equal to intrinsic value of $124.00.
   A warrant always trades above its intrinsic value due to its time value. Further discussion of the time value of options and warrants is a fundamental matter beyond the scope of the present claims. But, because The Cash xPRT converts into a Warrant when the Stock is at or above the $145.00 Target Price Pt, the Warrant's intrinsic value (minimum value) at issuance must be at least $124.00 (1.2000* $145.00−$50.00=$124.00).
   The Investor may immediately choose to sell the Warrant (or exercise it and sell the shares). The initial value of the Warrant will provide a return on investment to the investor equal to the “Keep” (measured at Target Price Pt, Keep equals $124.00) giving the investor a “Minimum Upside Participation” return of 24.0%. Because of the inherently long-term nature of a stock investment and the inherently short-term nature of a warrant investment, it is anticipated that the Investor may sell the Cash xPRT shortly before Acceleration or sell the Warrant shortly after Acceleration.
   Traders/Arbitrageurs (open market Warrant purchasers and/or Investors who continue to hold Warrants after the initial Cash xPRT conversion): Receive an indeterminate return between −100% (if stock price goes to the Warrant's $41.67 strike price per share at Warrant expiration) and infinite (if stock price goes to infinite at the time of the Warrant's expiration).
   ii) Warrant expires: The Warrant is not exercised by the Investor or Traders because the stock price at expiration after Acceleration is below the Warrant's $41.67 strike price per share ($50.00 cash consideration required on exercise to purchase 1.2000 shares). Warrant expires worthless (before consideration of Liquidation Value; Liquidation Value will be considered separately as an Underwritten Offering).
   Analysis—Scenario 1 Variation ii (Acceleration Plus Warrant Expiration)
   Issuer: Receives no cash but retires into 35.0 million shares (35.0% of outstanding shares) at a cost of $0.
   Investor: Earns a minimum return of 24.0% (same as Scenario li above).
   Traders/Arbitrageurs: On average suffer 100% loss.
   iii) Warrant expires in an Underwritten Offering: The warrant is not exercised by Investors or Traders because the stock price is below the Warrant's $41.67 effective per share strike price, but the transaction is underwritten and the Warrant carries a $100.00 Liquidation Value guaranteed by the Underwriter.
   The intrinsic value of the Warrant at the $145.00 Performance Target Pt is at least $124.00 (1.2000*$145.00−$50.00=$124.00 as discussed above).
   If the stock price subsequent to Acceleration falls to $125.00, then intrinsic value and Liquidation Value will both equal $100.00 Consequently, if the stock price trades at a price below $125.00 at Warrant Expiration, then in lieu of exercise, Investors and Traders will tender Warrants to the Underwriter for Liquidation Value. In the preferred mode of use (preferred form of Underwriter Guarantee), the Underwriter will be responsible for paying the $100.00 Liquidation Value to the tendering Warrant holder plus paying $50.00 to the Company in order to exercise the Warrant. In total, for each tendered Warrant, the Underwriter will pay $150.00 and receive 1.2000 shares at an effective price of $125.00 per share.
   Insofar as some portion of the Warrants are tendered by Investors, traders or others in lieu of exercise, then the Underwriter will purchase up to $5,250 million of Stock (up to 35.0 million Cash xPRTs tendered requiring Liquidation and Exercise payments of $150.00 apiece in return for receipt by the Underwriter of up to 42.0 million shares). $1,750 of the funds paid by the Underwriter go the Company and the remainder of the funds go to tendering Warrant holders.
   Due to the Underwriter Guarantee, the Warrant will be exercised regardless of whether or not the stock price is high enough (above $125.00) to be profitable to the Warrant holder. Once the Warrant is issued (i.e. once the $145.00 Performance Target Pt is achieved), the Issuer is assured receipt at Warrant Expiration of $1,750 million for sale of 7.0 million net new shares (35.0 million shares bought back through exchange, 42.0 million shares issued upon Warrant exercise, leaving a 7.0 million share net increase).
   Analysis—Scenario 1, Variation iii (Acceleration Plus Expiration in Underwritten Offering)
   Issuer: Receives $1,750 million for sale of 7.0 million net new shares effectively selling shares at $250.00 apiece once Acceleration is triggered regardless of subsequent stock price fluctuations. The $250.00 price is achieved even though the Company's stock price may never have traded significantly over the $145.00 Performance Target PT.
   Investor: Earns a minimum return of 24.0% (same as Scenario 1i above).
   Traders/Arbitrageurs: On average suffer a loss equal to the difference in the Warrant's initial value (equal to or greater than the “Keep” of $124.00) and the Liquidation Guarantee ($100.00)
   Underwriter: Places at risk $5,250 million of capital. Suffers a profit or loss that is a function of fees charged, the price and terms of the derivatives used (Underwriter Put), if any, to offset risk, and the degree to which at Warrant Expiration the stock is trading at a price below $125.00 per share. The Underwriter's risk (a contingent liability to purchase up to 42.0 million shares at of $125.00 per share for a total of risk $5,250 million) may be syndicated or otherwise laid off through the creation and marketing of “Knock in Puts” (“Underwriter's Puts”).
2) Scenario 2—Stock does not achieve the $145.00 Performance Target Pt within the 3 year Target Timeframe and at Maturity is trading at or below the $137.75 Cutback Target CBt:
Result: Each Cash xPRT converts in accordance with the Initial Leverage Lv1a (equal to the Initial Conversion Ratio) into 1.160 shares.
Analysis—Scenario 2
Issuer: Company issues 5.6 million net new shares at maturity representing a 5.3% potential earnings dilution factor. The Company has effectively sold Shares at $0 apiece. No cash flows into or out of the Company. Insofar as the original tender offer was accepted pro rata by existing shareholders, the result is similar to a stock dividend with the exception that management and other option holders do not participate in the dividend.
Investor (assuming Cash xPRT held to maturity): Earns between 59.8% (Transition Target Price times the Initial Conversion Ratio measured against the initial investment, i.e. $137.75*1.160 equals $159.79, a 59.8% gain vs. the $100 initial investment) and −100% (if the stock price declines to $0).
Scenario 3: Stock does not achieve the $145.00 Performance Target Pt within the 3 year Target Timeframe and at Maturity is trading between the $137.75 Cutback Target CBt price and the $145.00 Target Price at Maturity.
3) Result: The Cash xPRTs each convert into a number of stock shares determined by the Conversion Ratio, in this example defined by the constrained linear value formula:
   CR=−4.9366+839.80/x
   Where: “x” is Stock price at Maturity
Each Cash xPRT at Maturity converts in to a minimum of 0.855 shares (if at Maturity the Stock price equals the $145.00 Target Price (but does not trigger Acceleration) and a maximum of 1.160 shares (if the stock price at Maturity equals the $137.75 Cutback Target CBt).
Analysis—Scenario 3
Issuer: At best (Stock at Maturity at $145.00 Performance Target Pt), Issuer receives 5.1 million net shares for $0 consideration (begins by exchanging 35.0 million shares for 35.0 million Cash xPRTs; ends by converting each of the 35.0 million Cash xPRTs into 0.855 shares; result is a net reduction in shares outstanding of 5.1 million). At worst (Stock at Maturity at $137.75 Cutback Target CBt), Issuer issues 5.6 shares for $0 consideration (each of the 35.0 million Cash xPRTs converts into 1.160 shares). Insofar as the Cash xPRT exchange offer is accepted and held on a pro rata basis, any increase (or decrease) in shares outstanding amounts to a stock dividend (reverse dividend) and there is no dilution of ownership interest with the exception that option holders (typically Issuer management) do not participate in the dividend (and so will benefit from reverse dividends and be hurt by dividends).
Original Investor (assuming Cash xPRT held to Maturity): Earns between 59.8% ($137.75 Cutback Target CBt times*1.160 Initial Conversion Ratio Lv1a equals $159.79, a 59.8% gain vs. the $100 initial investment) and 24.0% ($145.00 Performance Target Pt times 0.855 Conversion Ratio equals $124.00, a 24.0% gain vs. the $100 initial investment).

Cash xPRTs are particularly applicable to transactions involving undervalued securities and for situations in which any type of debt security might be deemed inappropriate or counterproductive.

By issuing Cash xPRTs, a company may sell securities at a premium to the current market price.

The premium received through Cash xPRTs offerings may be particularly significant when structured as an exchange offer. In a Cash xPRTs exchange offer, the price received for new shares issued could be at a premium to the future price of the stock as well as a premium to the current price. A premium price can be secured by the issuer while still providing attractive returns to all participants (the issuer, the investor, and the hedging intermediary, if any).

The combinations of Cash xPRT features are numerous and together they provide substantial benefit over existing equity, debt, and hybrid instruments. Several of these features are of particular distinction and merit further explanation below.

The first feature of Cash xPRTs is a solicitation of companies to issue securities at above market prices through use, among other features, of an Option Conversion feature. In the case of the origination of Cash xPRTs through a cash sale, issuers would be solicited to sell stock at prices higher than either the current price of the company's stock and potentially higher than the future market price of its stock contingent upon reaching a minimum future stock price target. The above market price may be attained while providing a positive and/or acceptable risk return for all parties (the buyer, the seller, and the intermediary, if any). Primary issuers would be the companies that issue the prime underlying security; secondary issuers would include holders of large blocks of the prime underlying security or derivatives traders (brokerages) seeking to improve the efficiency of the market.

In the case of solicitations for companies to enter into “Cashless Buybacks” through the issuance of Cash xPRTs in an exchange offer (an exchange of Cash xPRTs for stock), the buyback may result in the company issuing stock at a price that may be very substantially above both the present and future price of the stock. The above market price may be attained while providing positive and/or acceptable risk return for all parties (the buyer, the seller, and the intermediary, if any).

Cash xPRT transactions, particularly when used for “Cashless Buybacks,” provide benefits to both the Issuer (i.e. the sale of securities at a premium price upon attainment of targets without risk of any cash outflow) and the Investor (i.e. reduced risk of loss, leveraged profit participation within a performance range, acceptable returns above that target range).

Cash xPRTs also provide advantages to the Issuer and Investor together as a group: Cash xPRT align the objectives of both parties to the health of the enterprise better than alternative financing means for undervalued companies such as equity or debt (equity may dilute existing investors; the servicing needs of debt may reduce enterprise value).

A second element of Cash xPRTs is their suitability for pubic trading by means of uniform features that easily conform to the terms of recognized securities and the related public exchange rules. Cash xPRTs may be constructed to conform to public exchange listing requirements and to include standardized features that will enhance their liquidity and contribute to the development of a robust market. Standardized features include those that are unique to Cash xPRTs in their terms or application (including, among others, “Conversion Option Acceleration”, “Keep”, “Give Back”, “Initial Conversion Ratio”, “Transition Conversion Formula”, “Ratchet Conversion”, “Target Conversion Ratio”, “Option Conversion Terms). Among other attributes, Cash xPRTs may be constructed in a described manner to be effectively hedged with existing financial instruments; and the construction of Cash xPRTs with standard features conforming to existing publicly traded securities and complemented by existing hedging instruments facilitates the creation of a broad and robust market that will enhance existing financial markets and contribute to overall capital efficiency.

A third feature is a defined role for the underwriting of Cash xPRTs. Underwriters may serve a role in Cash xPRTs originations or Cashless Buybacks. The identified and defined role provides a true and valuable service (risk redistribution). The service is of value to the Issuer and to the Investor. Consequently, Cash xPRT transactions may include a payment to an Underwriter for risk services that are unique in their size and type as applied to corporate finance, and the identification and assumption of those risks will further enhance capital efficiency.

With regard to enabling underwritten transactions and pricing those services, the optional Liquidation Value feature of Cash xPRTs (including its application through a Binary Conversion mechanism and in conjunction with other, related features such as Ratchets) is of particular value.

A Liquidation Value provides additional value to the Investor, and the Issuer may find the price of providing this value attractive. For instance, in a Cash xPRTs offering, after the Target has been attained, regardless of the Security's “true” or “expected” value, it is possible the Security nonetheless subsequently declines in price to such an extent that the Conversion Option at expiration has little or no value. In that case, if a Liquidation Value feature is provided, the Investor could choose to accept the Liquidation Value in lieu of exercising the Conversion Option.

An Issuer may find that providing a Liquidation Value feature is attractive either because it is sufficiently appealing to Investors to improve pricing, or because it encourages orderly trading, or for other reasons. At the same time, the Issuer may wish to “offload” to a third party (an “Underwriter”) the risk that the Issuer's Security does attain the Target but subsequently declines to such an extent that Investors prefer to exercise their right to receive the Liquidation Value rather than exercise their Conversion Options.

Normally, a successful Cash xPRT exchange offer results in an Issuer either issuing shares at a premium price or buying back shares for $0 consideration. The terms could be altered to permit only one of the alternatives. The most attractive alternative, however, may be to maintain the terms of the Cash xPRT in their entirety and include the services of an Underwriter. The Underwriter can guarantee which alternative (sales of shares at premium or repurchase of shares for $0 consideration) the Issuer will realize while maintaining the valuable features of the instrument for the Investor. The Liquidation Value can be either Cash (to assure the sale of shares at a premium price) or Securities (to assure the repurchase of Securities for $0 consideration). In the included example, Liquidation Value is cash.

A Cash xPRT that includes a Liquidation Value facilitates an underwriting: The risk that a Security rises from Spot to Target and subsequently declines to a point that triggers exercise of Liquidation Value is the type of risk that financial underwriters are equipped to deal with. The size and benefit of the underwriter's guarantee can be substantially larger than those that underwriters generally assume in equity transactions because the structure of the underwriter's potential obligation is amenable to hedging.

The structure of Cash xPRTs exposes to pricing, remarketing and hedging the high risk tranches of equity now embedded within securities. Combined with features that make Cash xPRTs suitable for high volume public exchanges, underwriters may be willing to guarantee unusually sizable contingent liabilities over extended timeframes.

The availability of sizable Underwriter Guarantees will enhance the efficiency of capital allocation between issuers, investors, underwriters and arbitrageurs. Benefits include issuers able to attract capital on more favorable terms, investors able to earn better returns with reduced risk, and greater depth and breadth (“robustness”) of capital markets due to increased participation by all parties (issuers, investors, underwriters, arbitrageurs).

A fourth element of Cash xPRTs is broker originations. Existing broker originated derivates face various enumerated disadvantages of existing publicly traded derivative securities. The specific terms and standardized features of Cash xPRTs avoid the shortfalls of existing hybrid instruments that has limited their penetration into high volume public markets. In addition, derivatives operations of major brokerage firms or others may find issuance of broker backed Cash xPRTs attractive. Brokers and derivative traders will more readily have access to the highest risk/reward tranches of equity securities while smaller investors could more readily purchase equity securities with reduced risk. Broker backed Cash xPRTs would require brokers to back the Option Conversion feature of the Cash xPRTs they issue, but the business of remarketing the “Broker Guarantee” could be equally as attractive as the business of remarketing the “Underwriters' Guarantee” for the Cash xPRT original issuance (company backed issuance) market.

Aside from the theoretical availability of “synthetics,” no financial instrument duplicates the features of Cash xPRTs. A Cash xPRT transaction may be constructed so that: 1) Cash only flows in to the Issuer, never out; 2) The price realized for the Cash xPRT is a complex function of the price of the underlying security (for instance, the stock price) that may allow the eventual sale of the underlying security at a premium price; 3) In instances where the Cash xPRT is issued against an underlying security that is equity, a Cash xPRT may be issued that carries neither interest nor debt obligation nor, ordinarily, any potential for default (willful default is the only possible default); 4) Cash xPRTs issued against underlying equity typically will not cause default on any debt covenants of existing obligations (assuming the Cash xPRTs themselves have been duly authorized as an equity issuance); 5) The transaction itself is amenable to a valuable underwriting function to allow an unusual division of risk tranches between investors, underwriters, speculators, and arbitrageurs.

The financial instrument has particular value to a company with undervalued stock. In that case, a company may execute a cashless buyback. To accomplish this, a company first determines that its stock is undervalued. Next, the company uses projected data to determine the terms and conditions of the Cash xPRT. Preferably, the company constructs a Cash xPRT with a linear initial conversion ratio. Then, the company determines an exchange ratio wherein a Cash xPRT is exchanged for an existing share. Preferably, the ratio is 1 to 1. Next, the company offers to exchange Cash xPRTs for outstanding stock based on the exchange ratio. Finally, investors either accept the offer or reject the offer.

This method of sale is beneficial in that a company can effectively repurchase some of its shares for no money. Alternatively, if the Cash xPRT is converted, it will be purchased at a substantial premium. The exchange transaction is beneficial because it is anti-dilutive.

In addition, it is preferred that the exchange is underwritten. An underwriter can make guarantees to either the investor, the company or both, effectively spreading the risk to any of the three parties. The risk can be structured to best match the parties' needs.

While the present invention has been described with reference to a preferred model of transactions (as well as some variants thereof), which have been set forth in considerable detail for the purposes of making a complete disclosure of the invention, such a model is merely exemplary and is not intended to be limiting or to represent an exhaustive enumeration of all aspects of the invention.

1. A financial instrument comprising:
an underlying stock;
an initial conversion ratio;
wherein said ratio is defined by a conversion ratio formula;
a performance target price;
a conversion option with terms;
and an acceleration clause.

2. The financial instrument of claim 1 further comprising a transition target price, a transition range, and a transition conversion formula.

3. The financial instrument of claim 1 further comprising a ratchet feature.

4. The financial instrument of claim 1 wherein said financial instrument is underwritten.

5. The financial instrument of claim 4 wherein further comprising a liquidation clause.

6. The financial instrument of claim 1 wherein the price of said financial instrument is determined by at least one selected from the group consisting of inspection of the marginal differential return option premiums, a comparison of publicly available options, and using the theoretical value of the deconstructed components of said instrument.

7. The financial instrument of claim 4 wherein the price of said financial instrument is determined by an underwritten value equation.

8. A financial instrument comprising:
an underlying stock;
a variable initial conversion ratio;
wherein said variability is defined by a constrained linear equation;
a performance target price;
a conversion option with terms;
and an acceleration clause.

9. The financial instrument of claim 8 further comprising a transition target price, a transition range, and a transition conversion formula.

10. The financial instrument of claim 8 further comprising a ratchet feature.

11. The financial instrument of claim 8 wherein said financial instrument is underwritten.

12. The financial instrument of claim 11 wherein further comprising a liquidation clause.

13. The financial instrument of claim 8 wherein the price of said financial instrument is determined by at least one selected from the group consisting of inspection of the marginal differential return option premiums, a comparison of publicly available options, and using the theoretical value of the deconstructed components of said instrument.

14. The financial instrument of claim 11 wherein the price of said financial instrument is determined by an underwritten value equation.

15. A method of offering a cashless buyback comprising the steps of:
providing a first party;
wherein said first party has outstanding stock;
providing a second party,
wherein said second party owns at least one share of said outstanding stock;
providing a financial instrument;
wherein said financial instrument comprises:
an underlying stock;
a variable initial conversion ratio;
a performance target price;
a conversion option with terms;
and an acceleration clause; and
wherein said first party offers to exchange said financial instrument to said second party for said at least one share of owned stock.

16. The method of claim 15 further comprising a transition target price, a transition range, and a transition conversion formula.

17. The method of claim 15 further comprising a ratchet feature.

18. The method of claim 15 wherein said financial instrument is underwritten.

19. The method of claim 18 wherein said financial insrtument further comprises a liquidation clause.

20. The financial instrument of claim 15 wherein the price of said financial instrument is determined by at least one selected from the group consisting of inspection of the marginal differential return option premiums, a comparison of publicly available options, and using the theoretical value of the deconstructed components of said instrument.

21. A method of offering a cashless buyback comprising the steps of:
providing a first party;
wherein said first party has outstanding stock;
providing a second party,
wherein said second party owns at least one share of said outstanding stock;
providing a financial instrument;
wherein said financial instrument comprises:
an underlying stock;
an initial conversion ratio;
wherein said ratio is defined by a conversion ratio formula;
a performance target price;
a conversion option with terms;
and an acceleration clause;
providing a third party;
wherein said third party guarantees said financial instrument to at least one of said first and said second parties by providing a liquidation clause associated with said financial instrument; and
wherein said first party offers to exchange said financial instrument to said second party for said at least one share of owned stock.

22. The financial instrument of claim 21 further comprising a transition target price, a transition range, and a transition conversion formula.

23. The financial instrument of claim 21 further comprising a ratchet feature.

24. The financial instrument of claim 21 wherein the price of said financial instrument is determined by an underwritten value equation.
